(19) United States
(12) Patent Application Publication
(10) Pub. No.: US 2012/0212566 A1
(43) Pub. Date: Aug. 23, 2012

(54) LIGHT EMITTING COMPONENT, PRINT HEAD, AND IMAGE FORMING APPARATUS

(75) Inventors: Takashi KIKUCHI, Kanagawa (JP); Roshan THAPLIYA, Kanagawa (JP); Shigetoshi NAKAMURA, Kanagawa (JP)

(73) Assignee: FUJI XEROX CO., LTD., Tokyo (JP)

(21) Appl. No.: 13/189,008

(22) Filed: Jul. 22, 2011

(30) Foreign Application Priority Data
Feb. 18, 2011 (JP) 2011-033869

(51) Int. Cl. B41J 27/00; G02B 3/00; G02B 3/06

(52) U.S. Cl. 347/258; 359/754; 359/710

(57) ABSTRACT

A light emitting component includes plural of light emitting elements arranged in rows on a substrate, plural lenses provided to face light emitting faces to which light beams of the plural light emitting elements are emitted, and condensing the light beams emitted from the light emitting elements, and one or plural pedestals holding the lenses such that the light emitting faces of the respective light emitting elements of the plural light emitting elements and the lenses that face the light emitting elements face the light emitting faces via gaps.

### CROSS-REFERENCE TO RELATED APPLICATIONS

This application is based on and claims priority under 35 USC 119 from Japanese Patent Application No. 2011-033869 filed Feb. 18, 2011.

### BACKGROUND

(i) Technical Field

The present invention relates to a light emitting component, a print head, and an image forming apparatus.

(ii) Related Art

In order to condense and efficiently extract the light emitted from the light emitting faces of a light emitting element array in a light emitting component having the light emitting element array in which plural light emitting faces are arranged in rows, lenses (micro lenses or micro beads) are provided in correspondence with the respective light emitting faces.

### SUMMARY

According to an aspect of the invention, there is provided a light emitting component including plural light emitting elements arranged in rows on a substrate; plural lenses provided to face light emitting faces to which light beams of the plural light emitting elements are emitted, and condensing the light beams emitted from the light emitting elements; and one or plural pedestals holding the lenses such that the light emitting faces of the respective light emitting elements of the plural light emitting elements and the lenses that face the light emitting elements face the light emitting faces via gaps.

### BRIEF DESCRIPTION OF THE DRAWINGS

Exemplary embodiments of the present invention will be described in detail based on the following figures, wherein:

FIG. 1 is a view showing an example of the overall configuration of an image forming apparatus to which a first embodiment is applied;

FIG. 2 is a sectional view showing the configuration of a print head;

FIG. 3 is a top view of a light emitting device;

FIGS. 4A and 4B are views showing the configuration of light emitting chips, the configuration of a signal generating circuit of the light emitting device, and the configuration of the wiring (lines) on a circuit board;

FIG. 5 is an equivalent circuit diagram for describing the circuit configuration of a light emitting chip on which a self-scanning type light emitting element array (SLED) is mounted;

FIGS. 6A and 6B are a plan layout pattern and a sectional view of the light emitting chip to which the first embodiment is applied;

FIGS. 7A to 7D are sectional views describing a method of providing lenses of the light emitting chip;

FIG. 8 is a timing chart for describing the operation of the light emitting device and the light emitting chip;

FIGS. 9A to 9C are a plan view and sectional views of some of light emitting thyristors of a light emitting chip in a second embodiment;

FIGS. 10A to 10C are a plan view and sectional views of some of light emitting thyristors of a light emitting chip in a third embodiment;

FIGS. 11A to 11C are a plan view and sectional views of some of light emitting thyristors of a light emitting chip in a fourth embodiment;

FIGS. 12A to 12C are a plan view and sectional views of some of light emitting thyristors of a light emitting chip in a fifth embodiment; and

FIGS. 13A to 13C are a plan view and sectional views of some of light emitting thyristors of a light emitting chip in a comparative example.

### DETAILED DESCRIPTION

In image forming apparatuses, such as a printer, a copying machine, and a facsimile, which adopt an electrophotographic system, an electrostatic latent image is obtained by irradiating image information onto a uniformly charged photoreceptor by an optical recording unit, and then, the electrostatic latent image is visualized by developing a toner thereto, and is transferred onto and fixed on a recording medium, thereby performing image formation. As this optical recording unit, in addition to a light scanning system that performs scanning and exposure with laser light in a main scanning direction using a laser, in recent years, a recording device using an LED print head (LPH: LED Print Head) that is formed by arraying a number of light emitting diodes (LED) as light emitting elements in the main scanning direction in response to a demand for miniaturization of an apparatus is adopted.

Additionally, in a light emitting chip in which plural light emitting elements are provided in rows on a substrate, and self-scanning type light emitting element arrays (SLED) whose sequential lighting is controlled are mounted, light emitting thyristors are used as the light emitting elements. Since the light emitting thyristors have pnpn four-layer structure unlike the light emitting diodes, and emit light mainly in two inner layers of the four-layer structure, there is a feature that the quantity (light quantity) of the light that may be extracted to the outside is smaller than that of general light emitting diodes of two simple layers. Hence, in the light emitting thyristors, in order to increase the quantity of light emitted from the respective light emitting elements, it is further required to widen light emitting faces from which the light of the light emitting elements is emitted, and efficiently extract light from the light emitting element.

Exemplary embodiments of the invention will be described below in detail with reference to the accompanying drawings.

### First Embodiment

### Image Forming Apparatus 1

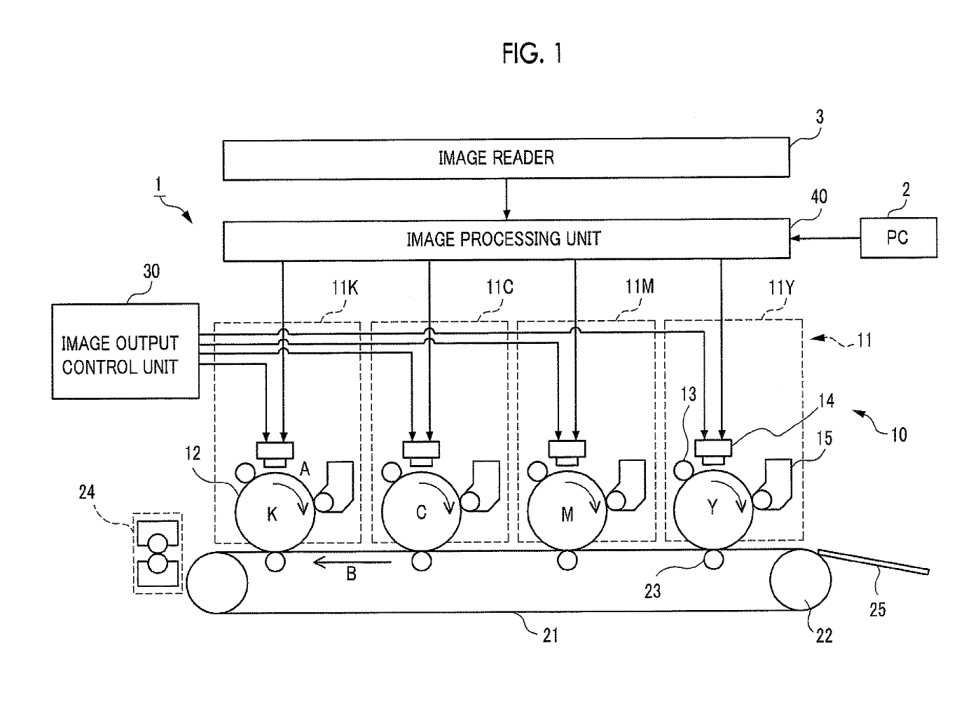

FIG. 1 is a view showing an example of the overall configuration of an image forming apparatus 1 to which a first embodiment is applied. The image forming apparatus 1 shown in FIG. 1 is an image forming apparatus generally referred to as a tandem type. This image forming apparatus 1 is equipped with an image forming process unit 10 that performs image formation in correspondence with image data of respective colors, an image output control unit 30 that controls image forming process unit 10, and an image processing unit 40 that is connected to, for example, a personal computer (PC) 2 and an image reader 3, and performs predetermined image processing on the image data received from the personal computer (PC) and image reader.

The image forming process unit 10 is equipped with an image forming device 11 including plural engines that are arranged in parallel at predetermined intervals. The image forming device 11 is composed of four image forming units 11Y, 11M, 11C, and 11K. The image forming units 11Y, 11M, 11C, and 11K are respectively equipped with a photoreceptor drum 12 as an example of an image carrier that forms an electrostatic latent image to carry a toner image, a charger 13 as an example of a charging unit that charges the surface of the photoreceptor drum 12 with predetermined potential, a print head 14 that exposes the photoreceptor drum 12 charged by the charger 13, and a developing device 15 as an example of a developing unit that develops the electrostatic latent image formed by the print head 14. The image forming units 11Y, 11M, 11C, and 11K form yellow (Y), magenta (M), cyan (C), and black (K) toner images, respectively.

Additionally, in order to multi-transfer respective color toner images formed on the photoreceptor drums 12 of the respective image forming units 11Y, 11M, 11C, and 11K to a recording paper 25 as an example of a recording medium to be transferred, the image forming process unit 10 is equipped with a paper transporting belt 21 that transports the recording paper 25, a driving roll 22 that is a roll that drives the paper transporting belt 21, a transfer roller 23 as an example of a transfer unit that transfers the toner images of the photoreceptor drums 12 to the recording paper 25, and a fixing device 24 that fixes the toner images onto the recording paper 25.

In the image forming apparatus 1, the image forming process unit 10 performs an image formation operation on the basis of various control signals supplied from the image output control unit 30. Under the control by the image output control unit 30, the image data received from the personal computer (PC) 2 and the image reader 3 is subjected to image processing by the image processing unit 40, and is supplied to the image forming device 11. For example, in the image forming unit 11K for black (K), the photoreceptor drum 12 is charged with predetermined potential by the charger 13 while being rotated in the direction of an arrow A, and is exposed by the print head 14 that emits light on the basis of the image data supplied from the image processing unit 40. Thereby, an electrostatic latent image concerning a black (K) image is formed on the photoreceptor drum 12. The electrostatic latent image formed on the photoreceptor drum 12 is developed by the developing device 15, and a black (K) toner image is formed on the photoreceptor drum 12. In the image forming units 11Y, 11M, and 11C, yellow (Y), magenta (M), and cyan (C) toner images are also formed, respectively.

The respective color toner images on the photoreceptor drums 12 formed by the respective image forming units 11 are sequentially electrostatically transferred to the recording paper 25 supplied with the movement of the paper transporting belt 21 that moves in the direction of an arrow B by the transfer electric field applied to the transfer roller 23, a multicolor toner image in which the respective color toners are superimposed on each other is formed on the recording paper 25.

Thereafter, the recording paper 25 to which the multicolor toner image has been electrostatically transferred is transported to the fixing device 24. The multicolor toner image on the recording paper 25 transported to the fixing device 24 is fixed to on the recording paper 25 in response to the fixing processing caused by heat and pressure by the fixing device 24, and is ejected from the image forming apparatus 1.

(Print Head 14)

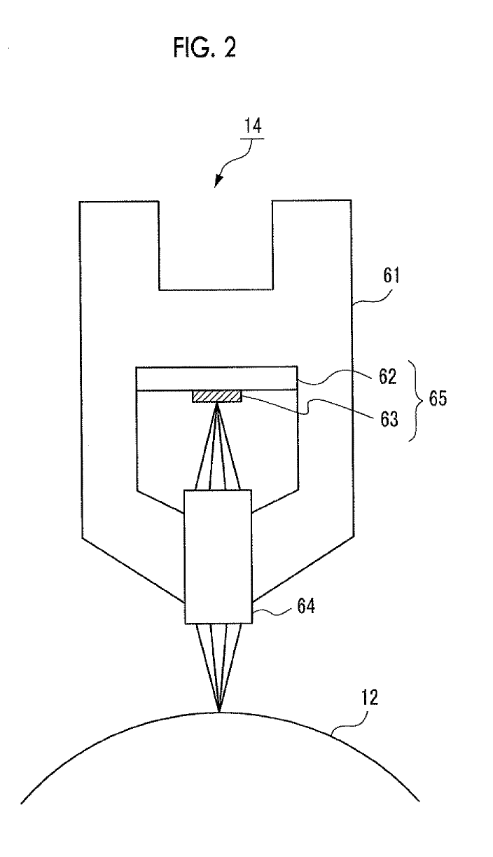

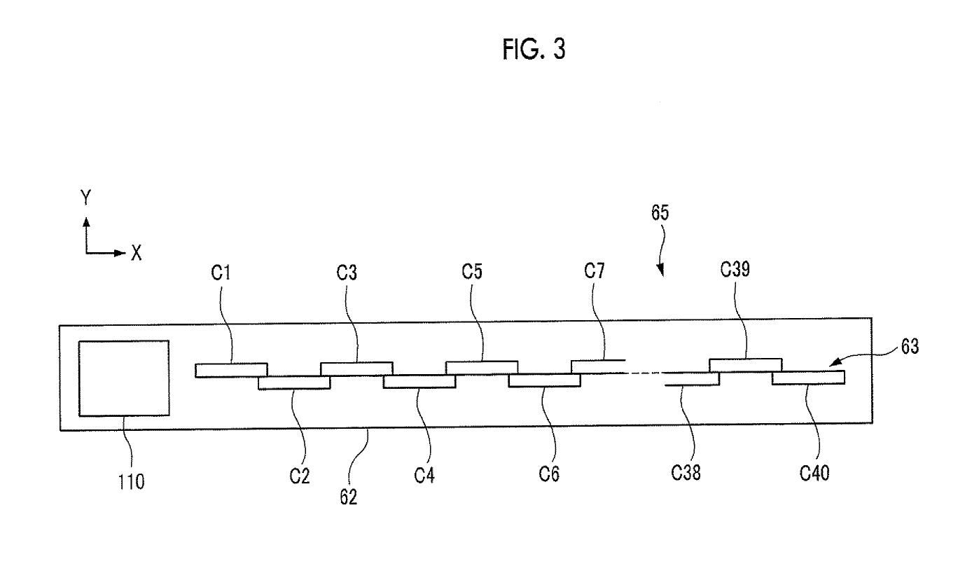

FIG. 2 is a sectional view showing the configuration of the print head 14. The print head 14 as an example of an exposure unit is equipped with a housing 61, a light emitting device 65 equipped with a light source unit 63 as an example of a light emitting unit equipped with plural light emitting elements (light emitting thyristors as an example of light emitting elements in the present exemplary embodiment) that expose the photoreceptor drum 12, and a rod lens array 64 as an example of an optical unit that focuses the light emitted from the light source unit 63 on the surface of the photoreceptor drum 12. The light emitting device 65 is equipped with the above-mentioned light source unit 63, and a circuit board 62 that mounts a signal generating circuit 110 (refer to FIG. 3 that will be described below) that drives the light source unit 63.

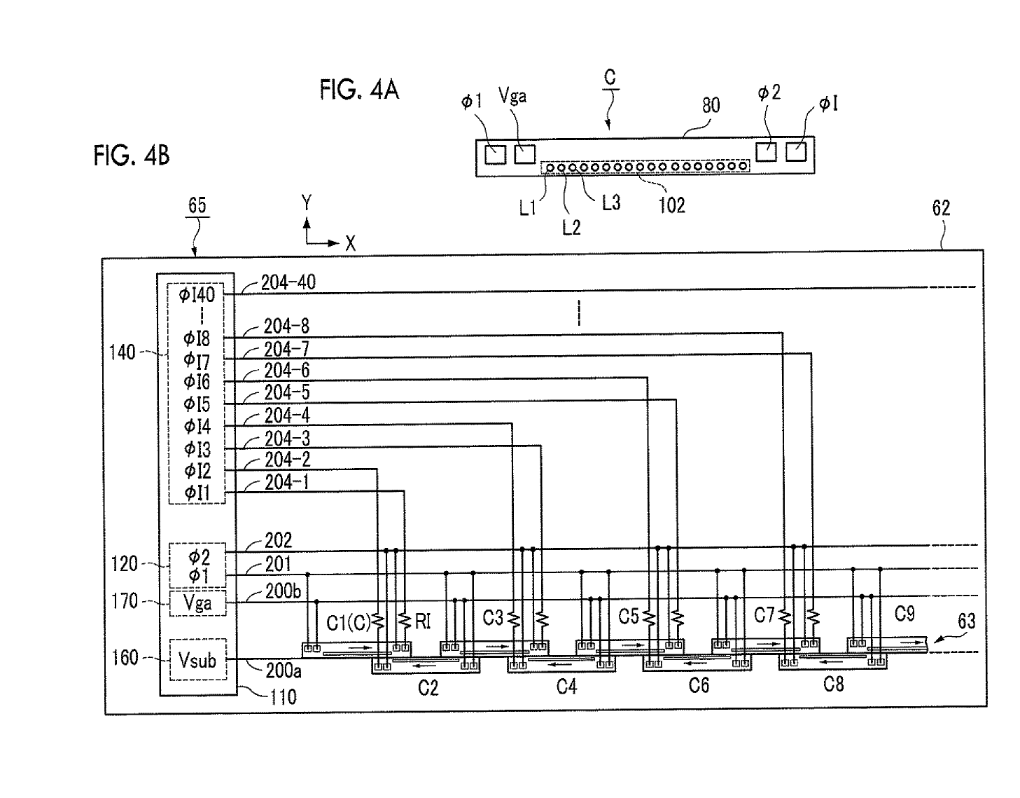

The housing 61 is formed from, for example, a metal, supports the circuit board 62 and the rod lens array 64, and is set such that light emitting points of the light emitting elements of the light source unit 63 are the focal plane of the rod lens array 64. Additionally, the rod lens array 64 is arranged along the axial direction (the X-direction of FIGS. 3 and 4B that is a main scanning direction and will be described below) of the photoreceptor drum 12.

(Light Emitting Device 65)

FIG. 3 is a top view of the light emitting device 65.

As shown in FIG. 3, in the light emitting devices 65, the light source unit 63 is configured such that light emitting chips C1 to C40 as an example of forty light emitting components are arranged in zigzags in two rows in the X-direction that is the main scanning direction on the circuit board 62.

In the present specification, the light emitting chips C1 to C40 include chips up to the light emitting chip C40 in numerical order from the light emitting chip C1.

The configuration of the light emitting chips C1 to C40 may be the same. Hence when the light emitting chips C1 to C40 are not distinguished, respectively, the light emitting chips are referred to as the light emitting chips C.

In addition, in the present exemplary embodiment, although forty in total is used as the number of the light emitting chips C, the number of the light emitting chips is not limited to this.

The light emitting device 65 mounts the signal generating circuit 110 that drives the light source unit 63, as mentioned above. The signal generating circuit 110 is composed of, for example, an integrated circuit (IC) or the like.

In addition, the array of the light emitting chips C1 to C40 will be described below.

FIG. 4A and FIG. 4B are views showing the configuration of the light emitting chips C, the configuration of the signal generating circuit 110 of the light emitting device 65, and the configuration of wiring (lines) on the circuit board 62. FIG. 4A is a view showing the configuration of the light emitting chips C, and FIG. 4B shows the configuration of the signal generating circuit 110 of the light emitting device 65, and the configuration of wiring (lines) on the circuit board 62.

First, the configuration of the light emitting chip C shown in FIG. 4A will be described.

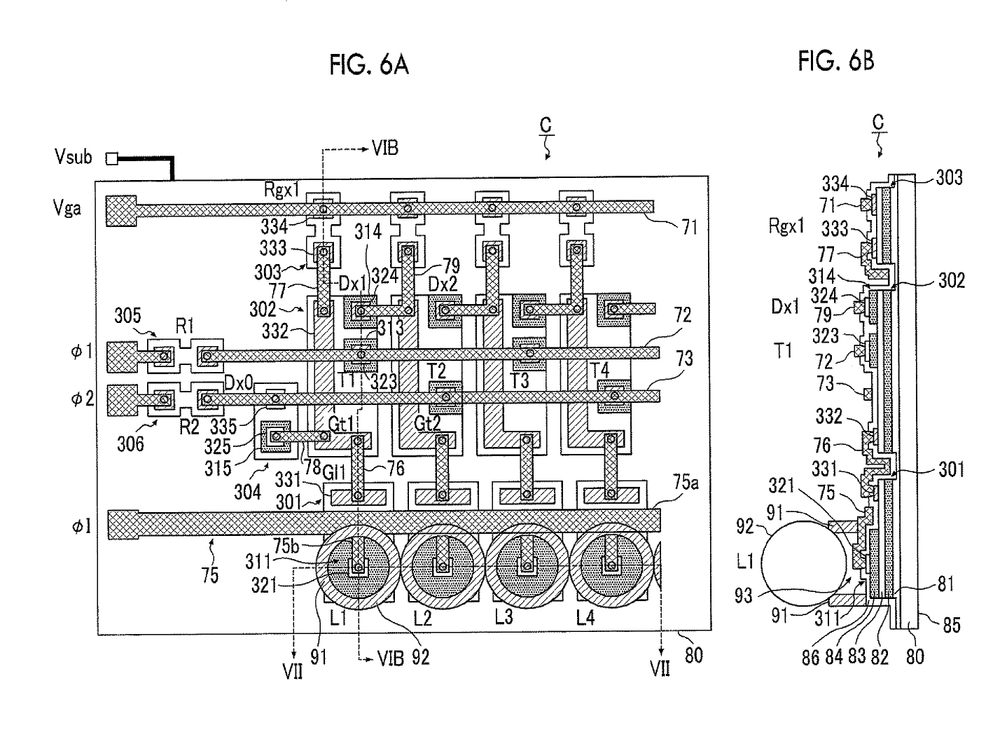

The light emitting chip C is equipped with a light emitting part 102 composed of plural light emitting elements (light emitting thyristors L1, L2, L3, etc. in the present exemplary embodiment) that are provided in rows along a long side near one side of long sides in the surface of a substrate 80 whose surface shape is rectangular. Moreover, the light emitting chip C is equipped with terminals (a φ1 terminal, a φ2 terminal, a Vga terminal, and φI terminal) that are plural bonding pads for fetching various control signals or the like into both ends of the surface of the substrate 80 in the direction of the long side. In addition, these terminals are provided in order of the φ1 terminal and the Vga terminal from one end of the substrate 80, and are provided in order of the φI terminal and the φ2 terminal from the other end of the substrate 80. The light emitting part 102 is provided between the Vga terminal and the φ2 terminal. Moreover, a back electrode 85 (refer to FIGS. 6A and 6B that will be described below) is provided on the back of the substrate 80 as a Vsub terminal.

In addition, the expression “in rows” is not limited to a case where plural light emitting elements are arranged on a straight line as shown in FIG. 4A, and may be a state where respective light emitting elements of plural light emitting elements are arranged with mutually different amounts of deviation in a direction orthogonal to the row direction. For example, when pixels are used as light emitting faces 311 (refer to FIGS. 6A and 6B that will be described below) of the light emitting elements, the respective light emitting elements may be arranged with amounts of deviation equivalent to several pixels or several tens of pixels in the direction orthogonal to the row direction. Additionally, the light emitting elements may be alternately arranged between adjacent light emitting elements, or arranged in zigzags at every plural light emitting elements.

Next, the configuration of the signal generating circuit 110 of the light emitting device 65 and the configuration of the wiring (lines) on the circuit board 62 will be described with reference to FIG. 4B.

As mentioned above, the signal generating circuit 110 and the light emitting chips C1 to C40 are mounted on the circuit board 62 of the light emitting device 65, and the wiring (lines) that connects the signal generating circuit 110 and the light emitting chips C1 to C40 is provided on the circuit.

First, the configuration of the signal generating circuit 110 will be described.

The image data and various control signals that have been image-processed are input to the signal generating circuit 110 from the image output control unit 30 and the image processing unit 40 (refer to FIG. 1). The signal generating circuit 110 performs rearrangement of image data, correction of the quantity of light, or the like on the basis of the image data and the various control signals.

The signal generating circuit 110 is equipped with a transmission signal generating unit 120 that transmits a first transmission signal φ1 and a second transmission signal φ2 to the light emitting chips C1 to C40 on the basis of the various control signals. Additionally, the signal generating circuit 110 is equipped with a lighting signal generating unit 140 that transmits lighting signals φI1 to φI40 to the light emitting chips C1 to C40, respectively, on the basis of the various control signals. In addition, when the lighting signals φI1 to φI40 are not distinguished, respectively, the lighting signals are represented as lighting signals φI.

Furthermore, the signal generating circuit 110 is equipped with a reference potential supply unit 160 that supplies a reference potential Vsub that becomes the reference of potential to the light emitting chips C1 to C40, and a power source potential supply unit 170 that supplies a power source potential Vga for driving of the light emitting chips C1 to C40.

Next, the array of the light emitting chips C1 to C40 will be described.

The odd light emitting chips C1, C3, C5, etc. are arranged in one row at intervals in the direction of the long side of the substrate 80, respectively. The even light emitting chips C2, C4, C6, etc. are also similarly arranged in one row at intervals in the direction of the long side of the substrate 80, respectively. The odd light emitting chips C1, C3, C5, etc. and the even light emitting chips C2, C4, C6, etc. are arranged in zigzags in the state of having rotated from each other by 180° such that the long sides near the light emitting part 102 side provided in the light emitting chips C face each other. The positions of the light emitting elements are set even between the light emitting chips C such that the light emitting elements are aligned at predetermined intervals in the main scanning direction. In addition, the directions of alignment (numerical order of the light emitting thyristors L1, L2, L3, etc. in the present exemplary embodiment) of the light emitting elements of the light emitting part 102 shown in FIG. 4A are indicated at the light emitting chips C1, C2, C3, etc. of FIG. 4B by arrows.

The wiring (lines) that connects the signal generating circuit 110 and the light emitting chips C1 to C40 will be described.

The circuit board 62 is provided with a power source line 200a that is connected to the Vsub terminal provided at the back electrode 85 (refer to FIGS. 6A and 6B that will be described below) that is the Vsub terminal of the light emitting chips C provided on the back of the substrate 80, and that supplies the reference potential Vsub.

The circuit board 62 is provided with the power source line 200b that is connected to the Vga terminal provided at the light emitting chips C, and that supplies the power source potential Vga for driving.

The circuit board 62 is provided with a first transmission signal line 201 for transmitting a first transmission signal φ1 to the φ1 terminal of the light emitting chips C1 to C40 from the transmission signal generating unit 120 of the signal generating circuit 110 and a second transmission signal line 202 for transmitting a second transmission signal φ2 to the φ2 terminal of the light emitting chips C1 to C40 from the transmission signal generating unit of the signal generating circuit. The first transmission signal φ1 and the second transmission signal φ2 are transmitted to the light emitting chips C1 to C40 in common (parallel).

Additionally, the circuit board 62 is provided with lighting signal lines 204-1 to 204-40 that transmit the lighting signals φI1 to φI40 to φI terminals of the respective light emitting chips C1 to C40, respectively, from the lighting signal generating unit 140 of the signal generating circuit 110.

As described above, the reference potential Vsub and the power source potential Vga are commonly supplied to all the light emitting chips C1 to C40 on the circuit board 62. The first transmission signal φ1 and the second transmission signal φ2 are also transmitted to the light emitting chips C1 to C40 in common (parallel). On the other hand, the lighting signals φI1 to φI40 are individually transmitted to the light emitting chips C1 to C40, respectively.

(Light Emitting Chip C)

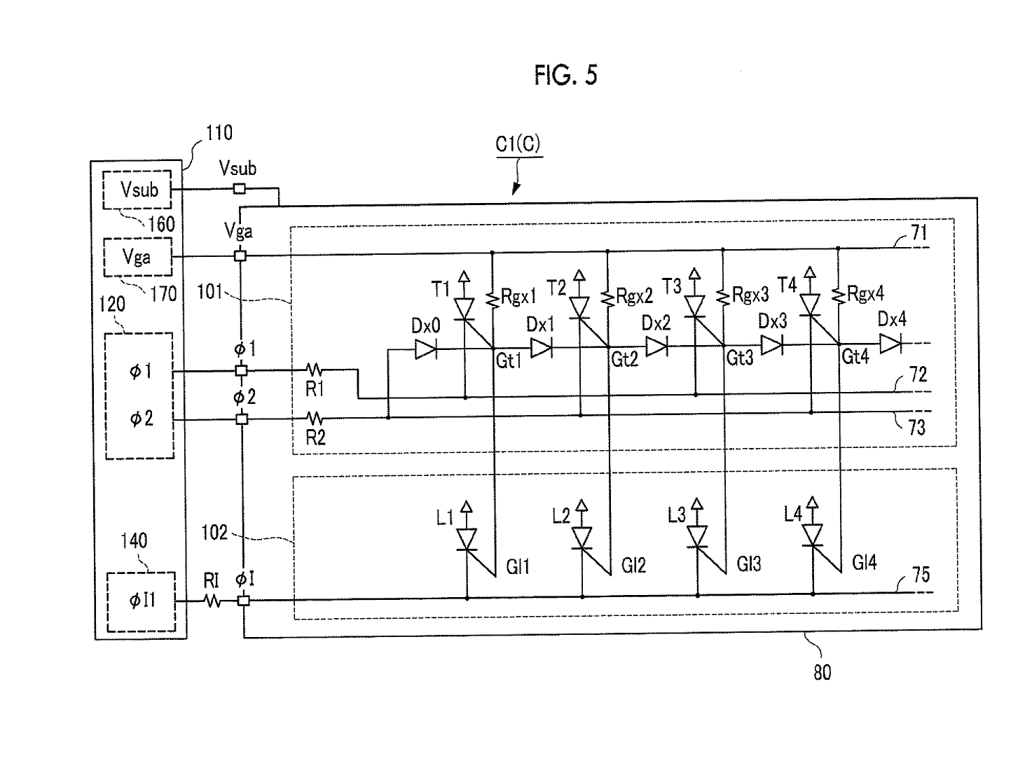

FIG. 5 is an equivalent circuit diagram for describing the circuit configuration of a light emitting chip C on which a self-scanning type light emitting element array (SLED) is mounted. The respective elements to be described below are arranged on the basis of the layout on the light emitting chip C (refer to FIGS. 6A and 6B that will be described below) except the terminals (the φ1 terminal, the φ2 terminal, the Vga terminal, and the φI terminal). In addition, although the positions of the terminals (the φ1 terminal, the φ2 terminal, the Vga terminal, and the φI terminal) are different from those of FIG. 4A, these terminals are shown at a left end in the drawing for convenience of description. The Vsub terminal provided on the back of the substrate 80 is shown so as to be pulled out to the outside of the substrate 80.

Here, the light emitting chips C will be described taking the light emitting chip C1 as an example in relation to the signal generating circuit 110. In FIG. 5, the light emitting chips C are represented as the light emitting chip C1 (C). The configuration of other light emitting chips C2 to C40 is the same as that of the light emitting chip C1.

The light emitting chip C1 (C) is equipped with a light emitting thyristor row (light emitting part 102 (refer to FIGS. 4A and 4B)) composed of the light emitting thyristors L1, L2, L3, etc. that are arranged in rows on the substrate 80 as mentioned above.

The light emitting chip C1 (C) is equipped with a transmission thyristor row composed of transmission thyristors T1, T2, T3, etc. that are arranged in rows similarly to the light emitting thyristor row.

Additionally, with every two of the transmission thyristors T1, T2, T3, etc. being made in pairs in twos in numerical order, respectively, the light emitting chip C1 (C) is equipped with coupling diodes Dx1, Dx2, Dx3, etc. between the transistors in each pair.

Moreover, the light emitting chip C1 (C) is equipped with power source line resistors Rgx1, Rgx2, Rgx3, etc.

Additionally, the light emitting chip C1 (C) is equipped with one start diode Dx0. The light emitting chip is also equipped with current-limiting resistors R1 and R2 that are provided in order to prevent an excessive current from flowing into the first transmission signal line 72 to which the first transmission signal φ1 that will be described below is transmitted and the second transmission signal line 73 to which the second transmission signal φ2 is transmitted.

The light emitting thyristors L1, L2, L3, etc. of the light emitting thyristor row, and the transmission thyristors T1, T2, T3, etc. of the transmission thyristor row, are arranged in numerical order from the left in FIG. 5. Moreover, the coupling diodes Dx1, Dx2, Dx3, etc., and the power source line resistors Rgx1, Rgx2, Rgx3, etc. are also arranged in numerical order from the left in the drawing.

The light emitting thyristor row and the transmission thyristor row are arranged in order of the transmission thyristor row and the light emitting thyristor row from the top in FIG. 5.

Here, when the light emitting thyristors L1, L2, L3, etc., the transmission thyristors T1, T2, T3, etc., the coupling diodes Dx1, Dx2, Dx3, etc., and the power source line resistors Rgx1, Rgx2, Rgx3, etc. are not distinguished, respectively, these are represented as the light emitting thyristors L, the transmission thyristors T, the coupling diodes Dx, and the power source line resistors Rgx, respectively.

The number of the light emitting thyristors L in the light emitting thyristor row may be a predetermined number. When the number of the light emitting thyristors L is set to 128 in the present exemplary embodiment, the number of the transmission thyristors T is also 128. Similarly, the number of the power source line resistors Rgx is also 128. However, the number of the coupling diodes Dx is 127 that is smaller than the number of the transmission thyristors T by one.

In addition, the number of the transmission thyristors T may be greater than the number of the light emitting thyristors L.

The above thyristors (the light emitting thyristors L and the transmission thyristors T) are semiconductor devices that have three terminals of a gate terminal, an anode terminal, and a cathode terminal.

Next, the electric connection between the respective elements in the light emitting chip C1 (C) will be described. The respective anode terminals of the transmission thyristors T and the light emitting thyristors L are connected to the substrate 80 of the light emitting chip C1 (C) (an anode common-type).

These anode terminals are connected to the power source line 200a (refer to FIGS. 4A and 4B) via the back electrode 85 (refer to FIGS. 6A and 6B that will be described below) that is the Vsub terminal provided on the back of the substrate 80. The reference potential Vsub is supplied to the power source line 200a from the reference potential supply unit 160.

The cathode terminals of the odd (odd-numbered) transmission thyristors T1, T3, etc. are connected to the first transmission signal line 72 along the array of the transmission thyristors T. The first transmission signal line 72 is connected to the φ1 terminal via the current-limiting resistor R1. The first transmission signal line 201 (refer to FIGS. 4A and 4B) is connected to the φ1 terminal, and the first transmission signal φ1 is transmitted to this terminal from the lighting signal generating unit 140.

On the other hand, the cathode terminals of the even (even-numbered) transmission thyristors T2, T4, etc. are connected to the second transmission signal line 73 along the array of the transmission thyristors T. The second transmission signal line 73 is connected to the φ2 terminal via the current-limiting resistor R2. The second transmission signal line 202 (refer to FIGS. 4A and 4B) is connected to the φ2 terminal, and the second transmission signal φ2 is transmitted to this terminal from the lighting signal generating unit 140.

The cathode terminals of the light emitting thyristors L1, L2, L3, etc. are connected to the lighting signal line 75. The lighting signal line 75 is connected to the φI terminal. In the light emitting chip C1, the φI terminal is connected to a lighting signal line 204-1 via the current-limiting resistor R1, and the lighting signal φI1 is transmitted to this terminal from the lighting signal generating unit 140. The lighting signal φI1 supplies a current for lighting to the light emitting thyristors L1, L2, L3, etc. In addition, lighting signal lines 204-2 to 204-40 are respectively connected to the φI terminals of the other light emitting chips C2 to C40 via the current-limiting resistors RI, and the lighting signals φI2 to φI40 are transmitted from the lighting signal generating unit 140.

Respective gate terminals Gt1, Gt2, Gt3, etc. of the transmission thyristors T1, T2, T3, etc. are connected to the gate terminals Gl1, Gl2, Gl3, etc. of the light emitting thyristors L1, L2, L3, etc. of the same numbers on a one-to-one basis. Hence, those having the same numbers in the gate terminals Gt1, Gt2, Gt3, etc. and the gate terminal Gl1, Gl2, Gl3, etc., have the same electrical potential. Hence, for example, representation as the gate terminal Gt1 (gate terminal Gl1) shows that potential is the same.

Here, when the gate terminals Gt1, Gt2, Gt3, etc. and the gate terminals Gl1, Gl2, Gl3, etc. are not distinguished, respectively, these gate terminals are represented as gate terminals Gt and gate terminals Gl. Representation as the gate terminals Gt (gate terminals Gl) shows that potential is the same.

The coupling diodes Dx1, Dx2, Dx3, etc. are respectively connected to between the gate terminals Gt in which the respective gate terminals Gt1, Gt2, Gt3, etc. of the transmission thyristors T1, T2, T3, etc. are made in pairs in twos in numerical order. That is, the coupling diodes Dx1, Dx2, Dx3, etc. are connected in series such that the coupling diodes are respectively pinched in order by the gate terminals Gt1, Gt2, Gt3, etc. The coupling diode Dx1 is connected in a direction in which a current flows from the gate terminal Gt1 toward gate terminal Gt2. The same is true for the other coupling diodes Dx2, Dx3, Dx4, etc.

The gate terminals Gt (gate terminals Gl) of the transmission thyristors T are connected to the power source line 71 via the power source line resistors Rgx provided in correspondence with the transmission thyristors T, respectively. The power source line 71 is connected to the Vga terminal. The power source line 200b is connected to the Vga terminal, and the power source potential Vga is supplied to this terminal from the power source potential supply unit 170.

The gate terminal Gt1 of the transmission thyristor T1 at one end of the transmission thyristor row is connected to the cathode terminal of the start diode Dx0. On the other hand, the anode terminal of the start diode Dx0 is connected to the second transmission signal line 73.

In FIG. 5, a part equipped with the transmission thyristors T, the coupling diodes Dx, the power source line resistors Rgx, the start diode Dx0, and the current-limiting resistors R1 and R2 of the light emitting chip C1 (C) is represented as a transmission part 101. Apart equipped with the light emitting thyristors L corresponds to the light emitting part 102.

FIGS. 6A and 6B are a plan layout pattern and a sectional view of the light emitting chip C. Here, since the connection relationship between the light emitting chip C and the signal generating circuit 110 is not shown, it is not required to take the light emitting chip C1 as an example. Hence, this chip is represented as the light emitting chip C.

FIG. 6A is a plan layout pattern of the light emitting chip C, showing a part mainly having the light emitting thyristors L1 to L4 and the transmission thyristors T1 to T4 as its center. In addition, although the positions of the terminals (the φ1 terminal, the φ2 terminal, the Vga terminal, and the φI terminal) are different from those of FIG. 4A, these terminals are shown at a left end in the drawing for convenience of description. The Vsub terminal provided on the back of the substrate 80 is shown so as to be pulled out to the outside of the substrate 80. Supposing that the terminals are provided so as to correspond to those of FIGS. 4A and 4B, the φ2 terminal, the φI terminal, and the current-limiting resistor R2 are provided at the right end of the substrate 80 in FIG. 6A. Additionally, the start diode Dx0 may be provided at the right end of the substrate 80.

FIG. 6B is a sectional view in the line VIB-VIB shown in FIG. 6A. Hence, the sections of the light emitting thyristor L1, the transmission thyristor T1, the coupling diode Dx1 and the power source line resistor Rgx1 are shown in the sectional view of FIG. 6B from the bottom thereof. In addition, in FIGS. 6A and 6B, main elements and terminals are represented on the basis of their names.

The light emitting chip C, as shown in FIG. 6B, is composed of plural islands where a first p-type semiconductor layer 81, a second n-type semiconductor layer 82, a third p-type semiconductor layer 83, and a fourth n-type semiconductor layer 84 are laminated in order. In addition, as will be described below, some islands of the plural islands have the fourth n-type semiconductor layer 84 partially or do not have the fourth n-type semiconductor layer 84.

As shown in FIG. 6B, the light emitting chips C is provided with an insulating layer 86 provided so as to cover the surfaces and lateral faces of these islands. These islands, and the wiring, such as the power source line 71, the first transmission signal line 72, the second transmission signal line 73, and the lighting signal line 75 are connected via openings (referred to as through holes) (shown by O in FIG. 6A) provided in the insulating layer 86. In the following descriptions, the description of the insulating layer 86 and openings is omitted.

As shown in FIG. 6A, a first island 301 is provided with the light emitting thyristor L1. As shown in FIG. 6B, a lens 92 is provided via a cylindrical (round tubular) pedestal 91 on the light emitting thyristor L1 (opposite side of the substrate 80). The external shape of the lens 92 is spherical (ball lens). The pedestal 91 holds the lens 92 such that the lens 92 faces the light emitting face 311 of the light emitting thyristor L1 via a gap (air space) 93. Here, the pedestal 91 is provided so as to be over the edge portions of the light emitting face 311. In addition, the pedestal 91 may be formed so as not to be formed on the light emitting face 311.

In addition, in FIG. 6A, the lens 92 is transparent, and only the external shape thereof is shown.

A second island 302 is provided with the transmission thyristors T1 and the coupling diode Dx1. A third island 303 is provided with the power source line resistors Rgx1. A fourth island 304 is provided with the start diode Dx0. A fifth island 305 is provided with the current-limiting resistor R1, and a sixth island 306 is provided with the current-limiting resistor R2.

Plural islands similar to the first island 301, the second island 302, and the third island 303 are formed in parallel in the light emitting chip C. These islands are provided with the light emitting thyristors L2, L3, L4, etc., the transmission thyristors T2, T3, T4, etc., and the coupling diodes Dx2, Dx3, Dx4, etc., similarly to the first island 301, the second island 302, and the third island 303. Plural lenses 92 are provided on the light emitting thyristor L1, L2, L3, etc., respectively. Additionally, as shown in FIG. 6B, the back electrode 85 that becomes the Vsub terminal is provided on the back of the substrate 80.

Here, the first island 301 to the sixth island 306 will be described in detail with reference to FIGS. 6A and 6B.

The light emitting thyristor L1 provided on the first island 301 has the first p-type semiconductor layer 81 provided on the p-type substrate 80 as an anode terminal, an n-type ohmic electrode 321 provided on the fourth n-type semiconductor layer 84 as a cathode terminal, and a p-type ohmic electrode 331 provided on the third p-type semiconductor layer 83 in which the fourth n-type semiconductor layer 84 is removed and exposed as the gate terminal Gl1. Light is transmitted and emitted through the insulating layer 86 from the surface of the fourth n-type semiconductor layer 84 excluding the portion in which emission of light is hindered (shielded) by the branch portions 75b for the connection between the n-type ohmic electrode 321 and the n-type ohmic electrode 321 of the lighting signal line 75, in the surface of the fourth n-type semiconductor layer 84. The emitted light is condensed and extracted by the lens 92. Here, the surface of the insulating layer 86 through which light is transmitted is used as the light emitting face 311.

The surface shape of the light emitting face 311 becomes a horseshoe shape as the branch portions 75b of the lighting signal line 75, and the n-type ohmic electrode 321 are formed on the surface of the fourth n-type semiconductor layer 84.

In the following, the term of the light emitting face 311 is used not only for the light emitting thyristor L1 but also for the other light emitting thyristors L.

The transmission thyristor T1 provided on the second island 302 has the first p-type semiconductor layer 81 provided on the p-type substrate 80 as an anode terminal, an n-type ohmic electrode 323 provided on a region 313 of the fourth n-type semiconductor layer 84 as a cathode terminal, and a p-type ohmic electrode 332 provided on the third p-type semiconductor layer 83 in which the fourth n-type semiconductor layer 84 is removed and exposed as the gate terminal Gt1.

Similarly, the coupling diode Dx1 provided on the second island 302 has an n-type ohmic electrode 324 provided on a region 314 of the fourth n-type semiconductor layer 84 as a cathode terminal, and a p-type ohmic electrode 332 provided on the third p-type semiconductor layer 83 as an anode terminal. The anode terminal of the coupling diode Dx1 and the gate terminal Gt1 of the transmission thyristors T1 are common in the p-type ohmic electrode 332.

In the power source line resistor Rgx1 provided on the third island 303, the third p-type semiconductor layer 83 between p-type ohmic electrodes 333 and 334 provided on the third p-type semiconductor layer 83 in which the fourth n-type semiconductor layer 84 is removed and exposed is provided as a resistor.

The start diode Dx0 provided on the fourth island 304 has an n-type ohmic electrode 325 provided on a region 315 of the fourth n-type semiconductor layer 84 as a cathode terminal, and a p-type ohmic electrode 335 provided on the third p-type semiconductor layer 83 in which the fourth n-type semiconductor layer 84 is removed and exposed as an anode terminal.

The current-limiting resistor R1 provided on the fifth island 305, and the current-limiting resistor R2 provided on the sixth island 306 have the third p-type semiconductor layer 83 between two p-type ohmic electrodes (with no reference numeral) as a resistor, respectively, similarly to the power source line resistor Rgx1 provided on the third island 303.

The connection relationship between the respective elements will be described in FIG. 6A.

The lighting signal line 75 is equipped with a stem portion 75a and plural branch portions 75b, the stem portion 75a is provided so as to extend in the row direction of the light emitting thyristor row, and the branch portions 75b branch off from the stem portion 75a, and are connected to the n-type ohmic electrodes 321 provided on the fourth n-type semiconductor layers 84 of the light emitting thyristors L1, L2, L3, etc.

The first transmission signal line 72 is connected to the n-type ohmic electrode 323 that is a cathode terminal of the transmission thyristor T1 provided on the second island 302. The cathode terminals of the other odd transmission thyristors T provided on islands similar to the second island 302 are also connected to the first transmission signal line 72. The first transmission signal line 72 is connected to the φ1 terminal via the current-limiting resistor R1 provided on the fifth island 305.

On the other hand, the second transmission signal line is connected to the n-type ohmic electrodes (with no reference numeral) that are cathode terminals of the even transmission thyristors T provided on islands with no reference numeral. The second transmission signal line 73 is connected to the φ2 terminal via the current-limiting resistor R2 provided on the sixth island 306.

The power source line 71 is connected to the p-type ohmic electrode 334 that is one terminal of the power source line resistor Rgx1. One-side terminals of the other power source line resistors Rgx are also connected to the power source line 71. The power source line 71 is connected to the Vga terminal.

The p-type ohmic electrode 331 (gate terminal Gl1) of the light emitting thyristor L1 provided on the first island 301 is connected to the p—type ohmic electrode 332 (gate terminal Gt1) of the second island 302 with connection wiring 76.

The p-type ohmic electrode 332 (gate terminal Gt1) is connected to the p-type ohmic electrode 333 (the other terminal of the power source line resistor Rgx1) provided on the third island 303 with connection wiring 77.

The n-type ohmic electrode 324 (cathode terminal of the coupling diode Dx1) provided on the second island 302 is connected to the p-type ohmic electrode (with no reference numeral) that is the gate terminal Gt2 of the transmission thyristor T2 provided adjacent thereto with connection wiring 79.

The p-type ohmic electrode 332 (gate terminal Gt1) of the second island 302 is connected to the n-type ohmic electrode 325 (the cathode terminal of the start diode Dx0) provided on the fourth island 304 with connection wiring 78. The p-type ohmic electrode 335 (the anode terminal of the start diode Dx0) is connected to the second transmission signal line 73.

Although description is omitted herein, The same is true for the other light emitting thyristors L, transmission thyristors T, coupling diodes Dx, and the like.

The light emitting chip C1 (C) shown in FIG. 5 is configured in this way.

(Method for Manufacturing Light Emitting Chip C)

A method for manufacturing a light emitting chip c will be described.

First, a method for manufacturing a light emitting chip C before lenses 92 are installed will be described.

The light emitting chip C forms plural islands (the first island 301 to the sixth island 306, and the island with no reference numeral) that are separated from each other by removing the fourth n-type semiconductor layer 84, the third p-type semiconductor layer 83, and the second n-type semiconductor layer 82, and the first p-type semiconductor layer 81 with a predetermined depth from the interface with the second n-type semiconductor layer 82 by etching after the first p-type semiconductor layer 81, the second n-type semiconductor layer 82, the third p-type semiconductor layer 83, and the fourth n-type semiconductor layer 84 are laminated in order on the p-type substrate 80 of, for example, compound semiconductors, such as GaAs and GaAlAs. Such islands are referred to as mesa, and etching for forming islands in this way is referred to as mesa-etching.

Moreover, in some islands among plural islands, the surface of the third p-type semiconductor layer 83 is exposed by removing a part or all of the fourth n-type semiconductor 84.

N-type ohmic electrodes, such as the n-type ohmic electrodes 321, 323, 324, and 325, are formed on the surface of the fourth n-type semiconductor layer 84, and P-type ohmic electrodes, such as the p-type ohmic electrodes 331, 332, 333, 334, and 335, are formed on the surface of the exposed third p-type semiconductor layer 83.

Then, the insulating layer 86, such as silicon dioxide (SiO₂), is formed so as to cover the surfaces and lateral faces of the exposed islands. Next, after openings are provided in the insulating layer 86 on the n-type ohmic electrodes and the p-type ohmic electrodes, for example, a metal films, such as an aluminum (Al), is deposited, and wiring, such as the power source line 71, the first transmission signal line 72, the second transmission signal line 73, and the lighting signal line 75 is processed by photolithography.

Thereby, the light emitting chip C before the lenses 92 are installed is manufactured.

Next, a method for installing the lenses 92 of the light emitting chip C will be described.

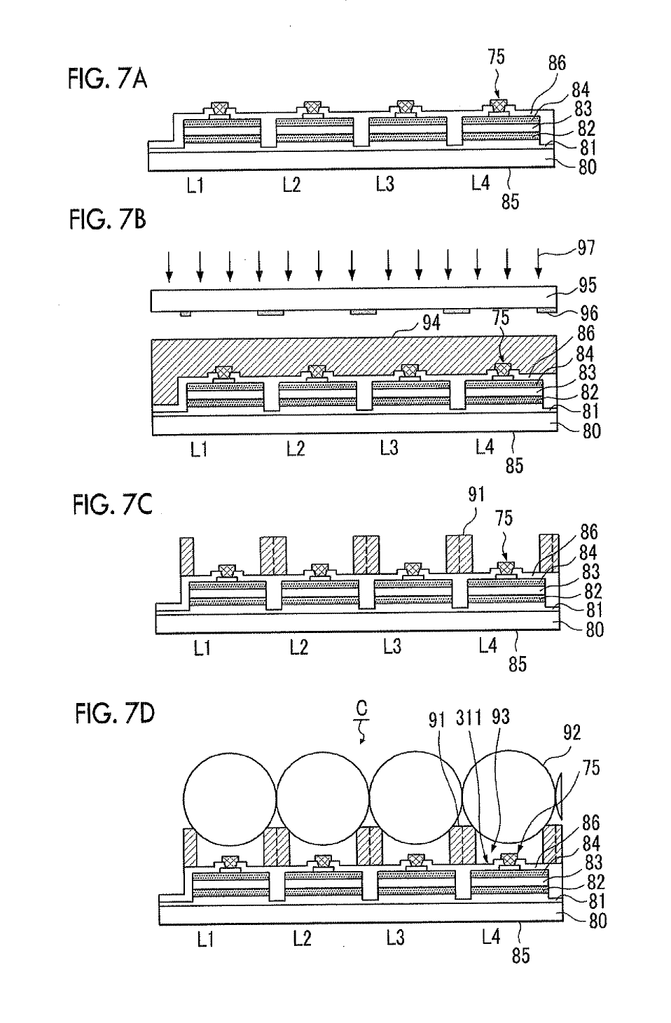

FIGS. 7A and 7D are sectional views describing the method of installing the lenses 92 of the light emitting chip C. Description is made in the section in the line VII-VII of FIG. 6A.

FIG. 7A shows the light emitting chip C before the aforementioned lenses 92 are installed. As shown in FIG. 7B, for example, a positive photosensitive polyimide film 94 is applied to the surface of the light emitting chip C before the lenses 92 are installed. The positive photosensitive polyimide film 94 has a property that the portion that is irradiated with light (ultraviolet light) 97 becomes soluble in a developer, while the portion that is not irradiated with the light 97 is insoluble in the developer.

Next, the light 97 to expose the photosensitive polyimide film 94 is radiated via a photo mask 95 in which a shielding portion 96 is formed from, for example, Cr or the like such that the portion that becomes the pedestal 91 is shielded.

Thereafter, the photosensitive polyimide film 94 that becomes soluble by the radiation of the light 97 is dissolved and removed if immersed in the developer. On the other hand, since the photosensitive polyimide film 94 of the portion that becomes the pedestal 91 is not irradiated with the light 97, the film remains without be dissolved by the developer.

As shown in FIG. 7C, a solvent contained in the photosensitive polyimide film 94 is evaporated by heating at a predetermined temperature, and the pedestal 91 is formed by imidizing a polyimide precursor of the photosensitive polyimide film 94.

Finally, as shown in FIG. 7D, the lenses 92, such as ball lenses, are arranged and fixed on the light emitting faces 311 of the light emitting thyristors L, respectively.

The diameter of the lenses 92 is set to the pitch of the light emitting thyristors L in the light emitting thyristor row. For example, when the pitch of the light emitting thyristors L is 20 μm, the diameter of the lenses 92 may be set to 20 μm. The height of the pedestal 91 is made great enough such that a gap 93 by an air space is formed between the light emitting face 311 and the lens 92.

The light emitting chip C equipped with the lenses 92 is manufactured in this way.

In addition, although the pedestal 91 is formed using the positive photosensitive polyimide film 94 in the above, a negative photosensitive polyimide film may be used. The negative photosensitive polyimide film has a property that a portion that is irradiated with the light 97 in a photosensitive polyimide film that is soluble in a developer becomes insoluble in the developer.

Moreover, a polyimide film that does not have photosensitivity, a film made of an inorganic material, such as SiO₂, and the like may be used instead of the photosensitive polyimide film. In these cases, the pedestal 91 may be processed using photolithography.

(Operation of Light Emitting Device 65)

Next, the operation of the light emitting device 65 will be described.

As mentioned above, the light emitting device 65 is equipped with the light emitting chips C1 to C40 (refer to FIG. 3 and FIGS. 4A and 4B).

As shown in FIGS. 4A and 4B, the reference potential Vsub and the power source potential Vga are commonly supplied to all the light emitting chips C1 to C40 on the circuit board 62. Similarly, the first transmission signal φ1 and the second transmission signal φ2 are transmitted to the light emitting chips C1 to C40 in common (parallel).

On the other hand, the lighting signals φI1 to φI40 are individually transmitted to the light emitting chips C1 to C40, respectively. The lighting signals φI1 to φI40 are signals that set the light emitting thyristors L of each of the light emitting chips C1 to C40 to lighting or non-lighting on the basis of image data. Hence, the lighting signals φI1 to φI40 have mutually different waveforms according to image data. However, the lighting signals φI1 to φI40 are transmitted in parallel at the same timing.

Since the light emitting chips C1 to C40 are driven in parallel, it is sufficient if the operation of the light emitting chip C1 is described.

<Thyristor>

Before the operation of the light emitting chip C1 is described, the basic operation of the thyristors (the transmission thyristors T and the light emitting thyristors L) will be described. The thyristors are semiconductor devices that have three terminals of a gate terminal, an anode terminal, and a cathode terminal.

In the following, as one example, description will be made with the reference potential Vsub supplied to the back electrode 85 (refer to FIGS. 5A and 5B and FIGS. 6A and 6B) that is the Vsub terminal being set to 0 V as a high-level potential (hereinafter represented as “H”.), and the power source potential Vga supplied to the Vga terminal being set to −3.3 V as a low-level potential (hereinafter represented as “L”).

In the present exemplary embodiment, the light emitting device 65 is driven by a negative potential.

Since the first p-type semiconductor layer 81 that is an anode terminal of a thyristor has the same potential as the p-type substrate 80, the anode terminal of the thyristor has the reference potential Vsub (“H” (0 V)) supplied to the back electrode 85.

As shown in FIGS. 6A and 6B, a thyristor is configured, for example by laminating the p-type semiconductor layers (the first p-type semiconductor layer 81 and the third p-type semiconductor layer 83) made of GaAs, GaAlAs, and the like, and the n-type semiconductor layers (the second n-type semiconductor layer 82 and the fourth n-type semiconductor layer 84). Here, description will be made with the forward potential (diffusion potential) Vd of a pn junction composed of a p-type semiconductor layer and an n-type semiconductor layer being set to 1.5 V as an example.

A thyristor in an OFF state in which a current is not flowing between an anode terminal and a cathode terminal shifts to an ON state, if a potential (a negative value with a large absolute value) lower than a threshold voltage is applied to the cathode terminal (turn-on). Here, the threshold voltage of the thyristor is a value obtained by subtracting the forward potential Vd (1.5 V) of the pn junction from the potential of the gate terminal. Hence, when the potential of the gate terminal of the thyristor is 0 V, the threshold voltage becomes −1.5 V. That is, when a potential lower than −1.5 V is applied to the cathode terminal, the thyristor is turned on. When the thyristor is tuned on, a state where a current flows to between the anode terminal and the cathode terminal (ON state) is brought about.

The potential of the gate terminal of the thyristor in an ON state becomes a potential near the potential of the anode terminal. Here, since the anode terminal is set to the reference potential Vsub (0 V (“H”)), the potential of the gate terminal will become 0 V (“H”). Additionally, the cathode terminal of the thyristor in an ON state has a potential near the potential obtained by subtracting the forward potential Vd (1.5 V) of the pn junction from the potential of the anode terminal. Here, since the anode terminal is set to the reference potential Vsub (0 V (“H”)), the potential of the cathode terminal of the thyristor in an ON state will become −1.5 V.

When the thyristor is once turned on, the potential of the cathode terminal becomes a potential (a negative value with a small absolute value, 0 V, or a positive value) higher than a potential that is required in order to maintain the ON state. That is, when a potential higher than −1.5 V is applied to the cathode terminal, the thyristor shifts to an OFF state (turn-off). For example, when the cathode terminal becomes “H” (0 V), the potential of the cathode terminal and the potential of the anode terminal will become the same while a potential higher than −1.5 V is obtained. Thus, the thyristor is turned off.

On the other hand, since the potential of the cathode terminal of the thyristor in an ON state is −1.5 V, a potential (a negative value with a large absolute value) lower than −1.5 V is continuously applied to the cathode terminal. When a current (maintaining current) capable of maintaining the ON state of the thyristor is supplied, the ON state is maintained. The light emitting thyristors L are lit (light emission) when turned on, and is unlit (non-lighting) when turned off. The quantity of light of the light emitting thyristors L in ON state is determined depending on the area of the light emitting face 311 and a current flowing between the cathode terminal and the anode terminal.

<Timing Chart>

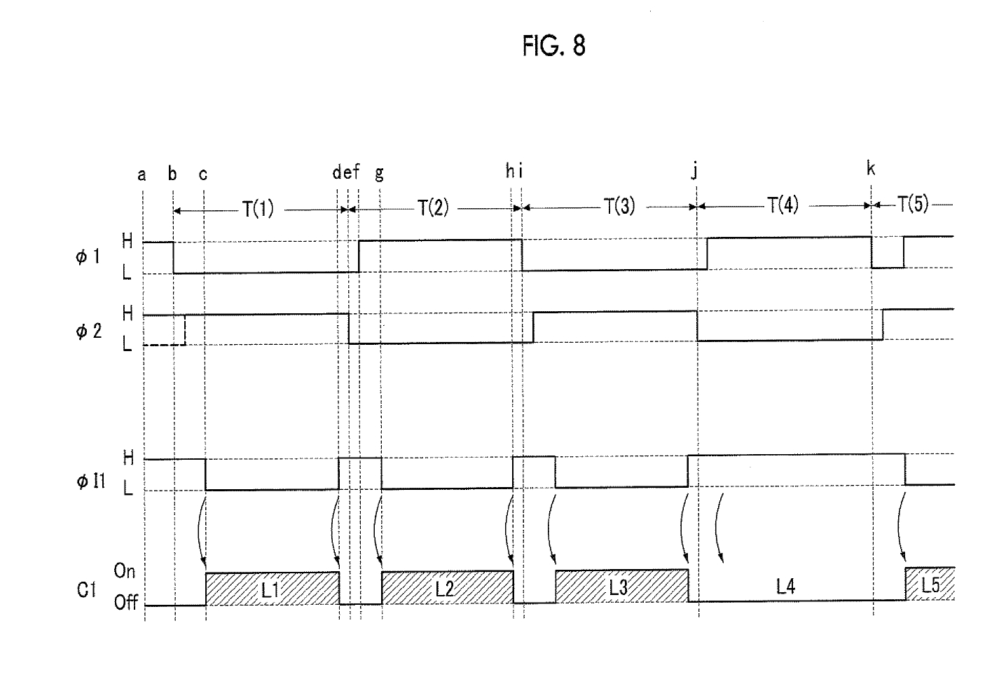

FIG. 8 is a timing chart for describing the operation of the light emitting device 65 and the light emitting chip C. FIG. 8 shows a timing chart of the portion that controls lighting or non-lighting of five light emitting thyristors L of the light emitting thyristors L1 to L5 of the light emitting chip C1 (it is written as lighting control.). As mentioned above, since the other light emitting chips C2 to C40 operate in parallel with the light emitting chip C1, it is sufficient if the operation of the light emitting chip C1 is described.

In addition, in FIG. 8, the light emitting thyristors L1, L2, L3, and L5 of the light emitting chip C1, are lit, and the light emitting thyristor L4 is unlit (non-lighting).

In FIG. 8, suppose that time passes in an alphabetical order from a time a to a time k. The light emitting thyristor L1, the light emitting thyristor L2 the light emitting thyristor L3, and the light emitting thyristor L4 are subjected to control (lighting control) of lighting or non-lighting in a period T(1) from a time b to a time e, in a period T(2) from the time e to a time i, in a period T(3) from the time i to a time j, and in a period T(4) from the time j to a time k, respectively. Hereinafter, lighting of light emitting thyristors L whose numbers are five or more is controlled similarly.

Here, the periods T(1), T(2), T(3), etc. are set to the period of the same length, and are referred to as a period T when the respective periods are not distinguished.

In addition, if the mutual relationship between the signals to be described below is maintained, the length of the periods T(1), T(2), T(3), etc. is made variable.

The waveforms of the first transmission signal φ1, the second transmission signal φ2, and the lighting signal φ1 will be described. In addition, the period from the time a to the time b is a period when the light emitting chip C1 (the light emitting chips C2 to C40 are also the same.) starts operation. The signal of this period will be described in the description of operation.

The first transmission signal φ1 transmitted to the φ1 terminal (refer to FIGS. 5A and 5B and FIGS. 6A and 6B) and the second transmission signal φ2 transmitted to the φ2 terminal (refer to FIGS. 5A and 5B and FIGS. 6A and 6B) are signals that have two potentials of “H” and “L”. The waveforms of the first transmission signal φ1 and the second transmission signal φ2 are repeated with two continuous periods T (for example, period T(1) and period T(2)) as a unit.

The first transmission signal φ1 shifts to “L” from “H” at the starting time b of the period T(1), and shifts to “H” from “L” at a time f. The first transmission signal shifts to “L” from “H” at the finishing time i of the period T(2).

The second transmission signal φ2 is “H” at the starting time b of the period T(1), and shifts to “L” from “H” at the time e. “L” is maintained at the finishing time i of the period T(2).

When the first transmission signal φ1 is compared with the second transmission signal φ2, the second transmission signal φ2 corresponds to a signal obtained by shifting the first transmission signal φ1 backward on the time axis by a period T. In the first transmission signal φ1, the waveform in the period T(1) and period T(2) is repeated after a period T(3). On the other hand, as for the second transmission signal φ2, the waveform shown by a broken line in the period T(1) and the waveform in the period T(2) are repeated after the period T(3). The reason why the waveform of the period T(1) of the second transmission signal φ2 is different from that after the period T(3) is because the period T(1) is a period during which the light emitting device 65 starts operation.

A set of transmission signals of the first transmission signal φ1 and the second transmission signal φ2, as will be described below, propagates the ON state of the transmission thyristors T shown in FIGS. 5A and 5B and FIGS. 6A and 6B in numerical order, thereby designating the light emitting thyristors L of the same numbers as the transmission thyristors T in an ON state as control (lighting control) targets of lighting or non-lighting.

Next, the lighting signal φI1 transmitted to the φI terminal of the light emitting chip C1 will be described. In addition, the lighting signals φI2 to φI40 are transmitted to the other light emitting chips C2 to C40, respectively. The lighting signal φI1 is a signal that has two potentials of “H” and “L”.

Here, the lighting signal φI1 will be described in the period T(1) of lighting control for the light emitting thyristor L1 of the light emitting chip C1. In addition, the light emitting thyristor L1 is lit.

The lighting signal φI1 is “H” at the starting time b of the period T (1), and shifts to “L” from “H” at the time c. The lighting signal shifts to “H” from “L” at the time d, maintains “H” at the finishing time e of the period T(1).

Then, the operation of the light emitting device 65 and the light emitting chip C1 will be described according to the timing chart shown in FIG. 8, referring to FIGS. 4A and 4B and FIG. 5. In addition, in the following, the periods T(1) and T(2) during which the lighting of the light emitting thyristors L1 and L2 is controlled will be described.

(1) Time a

<Light Emitting Device 65>

At the time a, the reference potential supply unit 160 of the signal generating circuit 110 of the light emitting device 65 sets the reference potential Vsub to “H” (0 V). The power source potential supply unit 170 sets the power source potential Vga to “L” (−3.3 V). Then, the power source line 200a on the circuit board 62 of the light emitting device 65 is set to have the reference potential Vsub of “H” (0 V), and the respective Vsub terminals of the light emitting chips C1 to C40 are set to have “H”. Similarly, the power source line 200b is set to have “L”, and the respective Vga terminals of the light emitting chips C1 to C40 are set to have “L” Thereby, the respective power source lines 71 of the light emitting chips C1 to C40 are set to have “L”.

The transmission signal generating unit 120 of the signal generating circuit 110 sets the first transmission signal φ1 and the second transmission signal φ2 to “H”, respectively. Then, the first transmission signal line 201 and the second transmission signal line 202 are set to have “H” (refer to FIG. 4). Thereby, the respective φ1 terminals and φ2 terminals of the light emitting chips C1 to C40 are set to have “H”. The potential of the first transmission signal line 72 connected to the φ1 terminal via the current-limiting resistor R1 is also set to “H”, and the potential of the second transmission signal line 73 connected to φ1 terminal via the current-limiting resistor R2 is also set to “H” (refer to FIG. 5).

Moreover, the lighting signal generating unit 140 of the signal generating circuit 110 sets the lighting signals φI1 to φI40 to “H”, respectively. Then, the potentials of the lighting signal lines 204-1 to 204-40 becomes “H” (refer to FIG. 4). Thereby, the respective φI terminals of the light emitting chips C1 to C40 are set to have “H” via the current-limiting resistors RI, and the lighting signal line 75 connected to the φI terminals is also set to have “H” (refer to FIG. 5).

Next, the operation of the light emitting chip C1 will be described.

In addition, although the potentials of the respective terminals change in the shape of a step (stairs) in FIG. 8 and the following description, the potentials of the respective terminals change gradually. Hence, if the conditions shown below are satisfied even on the way of changes in potential, the thyristors are turned on or turned off, and changes in state may occur.

(Light Emitting Chip C1)

Since the anode terminals of the transmission thyristors T and the light emitting thyristors L are connected to the Vsub terminal, these terminals are set to have “H” (0 V).

The respective cathode terminals of the odd transmission thyristors T1, T3, T5, etc. are connected to the first transmission signal line 72, and are set to have “H”. The respective cathode terminals of the even transmission thyristors T2, T4, T6, etc. are connected to the second transmission signal line 73, and are set to have “H”. Hence, since both the anode terminals and the cathode terminals have “H”, the transmission thyristors T are in an OFF state.

The cathode terminals of the light emitting thyristors L are connected to the lighting signal line 75 of “H”. Hence, since both the anode terminals and the cathode terminals have “H”, the light emitting thyristors L are in an OFF state.

The gate terminal Gt1 of one end of the transmission thyristor row in FIG. 5 is connected to the cathode terminal of the start diode Dx0 as mentioned above. The gate terminal Gt1 is connected to the power source line 71 of the power source potential Vga (“L” (−3.3 V)) via the power source line resistor Rgx1. The anode terminal of start diode Dx0 is connected to the second transmission signal line 73, and is connected to the φ2 terminal of “H” (0 V) via the current-limiting resistor R2. Hence, the start diode Dx0 has a forward bias, and the cathode terminal (gate terminal Gt1) of the start diode Dx0 has a value (−1.5 V) obtained by subtracting the forward potential Vd (1.5 V) of the pn junction from the potential (“H” (0 V)) of the anode terminal of the start diode Dx0. Additionally, when the gate terminal Gt1 has −1.5 V, since the anode terminal (gate terminal Gt1) has −1.5 V, and the cathode terminal is connected to the power source line 71 (“L” (−3.3 V)) via the power source line resistor Rgx2, the coupling diode Dx1 has a forward bias. Hence, the potential of the gate terminal Gt2 becomes −3 V obtained by subtracting the forward potential Vd (1.5 V) of the pn junction from the potential (−1.5 V) of the gate terminal Gt1. However, the influence that the anode terminal of the start diode Dx0 has “H” (0 V) is not exerted on the gate terminals Gt of three or more numbers, but the potentials of the gate terminals Gt become “L” (−3.3 V) that is the potential of the power source line 71.

In addition, since the gate terminals Gt are connected to the gate terminals Gl, the potentials of the gate terminals Gl are the same as the potentials of the gate terminals Gt. Hence, the threshold voltages of the transmission thyristors T and the light emitting thyristors L become the values obtained by subtracting the forward potential Vd (1.5 V) of the pn junction from the potentials of the gate terminals Gt and Gl. That is, the threshold voltages of the transmission thyristors T1 and the light emitting thyristors L1 become −3 V, the threshold voltages of the transmission thyristors T2 and the light emitting thyristors L2 become −4.5 V, and the threshold voltages of the transmission thyristors T and the light emitting thyristors L whose numbers are three or more become −4.8 V.

(2) Time b

At the time b shown in FIG. 8, the first transmission signal φ1 shifts to “L” (−3.3 V) from “H” (0 V). Thereby, the light emitting device 65 starts its operation.

When the first transmission signal φ1 shifts to “L” from “H”, the potential of the first transmission signal line 72 shifts to “L” from via the φ1 terminal and the current-limiting resistor R1. Then, the transmission thyristor T1 whose threshold voltage is −3 V is turned on. However, since the transmission thyristors T whose cathode terminals are connected to the first transmission signal line 72 and whose numbers are three or more odd numbers have a threshold voltage of −4.8 V, the thyristors may not be turned on. On the other hand, since the second transmission signal φ2 has “H” (0 V), and the second transmission signal line 73 has “H”, the even transmission thyristors T may not be turned on. As the transmission thyristor T1 is turned on, the potential of the first transmission signal line 72 is set to have −1.5 V obtained by subtracting the forward potential Vd (1.5 V) of the pn junction from the potential (“H” (0 V)) of the anode terminal.

When the transmission thyristor T1 is turned on, the potential of the gate terminal Gt1 is set to “H” (0 V) that is the potential of the anode terminal of the transmission thyristor T1. The potential of the gate terminal Gt2 becomes −1.5 V, the potential of the gate terminal Gt3 becomes −3 V, and the potentials of gate terminals Gt whose numbers are four or more become “L” (−3.3 V).

Thereby, the threshold voltage of the light emitting thyristor L1 becomes −1.5 V, the threshold voltages of the transmission thyristor T2 and the light emitting thyristor L2 become −3 V, the threshold voltages of the transmission thyristor T3 and the light emitting thyristor L3 become −4.5 V, and the threshold voltages of the transmission thyristors T and the light emitting thyristors L whose numbers are four or more become −4.8 V.

However, since the first transmission signal line 72 has −1.5 V by the transmission thyristor T1 in an ON state, the odd transmission thyristors T in an OFF state are not turned on. Since the second transmission signal line 73 has “HT”, the odd transmission thyristors T are not turned on. Since the lighting signal line 75 has “H”, all the light emitting thyristors L are not turned on.

Immediately after the time b (here, said of a case where a steady state is brought about after changes of the thyristors or the like have occurred due to changes in the potentials of signals at the time b), the transmission thyristors T1 is in an ON state, and the other transmission thyristors T and the light emitting thyristors L are in an OFF state.

(3) Time c

At the time c, the lighting signal φI1 shifts to “L” from “H”.

When the lighting signal φI1 shifts to “L” from “H”, the lighting signal line 75 shifts to “L” from “H” via the current-limiting resistors RI and φI terminals. Then, the light emitting thyristor L1 whose threshold voltage is −1.5 V is turned on, and lit (light emission). Thereby, the potential of the lighting signal line 75 is set to −1.5V. In addition, although the threshold voltage of the light emitting thyristor L2 is −3 V, since the light emitting thyristor L1 with as high (a negative value with a small absolute value) threshold voltage as −1.5 V is turned on and the lighting signal line 75 is set to have −1.5 V, the light emitting thyristor L2 is not turned on.

Immediately after the time c, the transmission thyristor T1 is in an ON state and the light emitting thyristor L1 is in an ON state and lit (light emission).

(4) Time d

At the time d, the lighting signal φI1 shifts to “H” from “L”. When the lighting signal φI1 shifts to “H” from “L”, the potential of the lighting signal line 75 shifts to “H” from “L” via the current-limiting resistors RI and φI terminals. Then, since both the anode terminal and the cathode terminal of the light emitting thyristor L1 are set to have “H”, the light emitting thyristor is turned off and unlit (non-lighting). The lighting period of the light emitting thyristor L1 becomes a period whose lighting signal φ1 has “L” from the time c when the lighting signal φI1 has shifted to “L” from “H” to the time d when the lighting signal φI1 shifts to “H” from “L”.

The transmission thyristor T1 is in an ON state immediately after the time d.

(5) Time e

At the time e, the second transmission signal φ2 shifts to “L” from “H”. Here, the period T(1) during which the lighting of the light emitting thyristor L1 is controlled is completed, and the period T(2) during which the lighting of the light emitting thyristor L2 is controlled is started.

When the second transmission signal φ2 shifts to “L” from “H”, the potential of the second transmission signal line 73 shifts to “L” from “H” via the φ2 terminal. As mentioned above, since the threshold voltage of the transmission thyristor T2 becomes −3 V, the transmission thyristor is turned on. Thereby, the potential of the gate terminal Gt2 (gate terminal Gl2) becomes “H” (0 V), the potential of the gate terminal Gt3 (gate terminal Gl3) becomes −1.5 V “H” (0 V), and the potential of the gate terminal Gt4 (gate terminal Gl4) becomes −3 V. The potentials of the gate terminals Gt (gate terminals Gl) whose numbers are five or more becomes −3.3 V.

Immediately after the time e, the transmission thyristors T1 and T2 are in an ON state.

(6) Time f

At the time f, the first transmission signal φ1 shifts to “H” from “L”.

When the first transmission signal φ1 shifts to “H” from “L”, the potential of the first transmission signal line 72 shifts to “H” from “L” via the φ1 terminal. Then, both the anode terminal and the cathode terminal of the transmission thyristor T1 in an ON state are set have to “H”, and transmission thyristor is turned off. Then, the potential of the gate terminal Gt1 (Gl1) changes via power source line resistor Rgx1 toward the power source potential Vga (“L” (−3.3 V)) of the power source line 71. Thereby, the coupling diode Dx1 is brought into a state (reverse bias) where the potential thereof is applied in a direction in which a current does not flow. Hence, the influence that the gate terminal Gt2 (gate terminal Gl2) has “H” (0 V) is not exerted on the gate terminal Gt1 (gate terminal Gl1). That is, the transmission thyristors T that have the gate terminals Gt connected at the coupling diodes Dx of a reverse bias have a threshold voltage of −4.8 V, and are not turned on at the first transmission signal φ1 or the second transmission signal φ2 of “L” (−3.3 V).

The transmission thyristor T2 is in an ON state immediately after the time f.

(7) Others

At the time g, when the lighting signal φI1 shifts to “L” from “H”, similarly to the light emitting thyristor L1 at the time c, the light emitting thyristor L2 is turned on, and is lit (light emission).

At the time h, when the lighting signal φI1 shifts to “H” from “L”, similarly to the light emitting thyristor L1 at the time d, the light emitting thyristor L2 is turned off, and is unlit.

Moreover, at the time i, when the first transmission signal φ1 shifts to “L” from “H”, similarly to the transmission thyristor T1 at the time b or the transmission thyristor T2 at the time e, the transmission thyristor T3 whose threshold voltage is −3 V is turned on. At the time i, the period T(2) during which the lighting of the light emitting thyristor L2 is controlled is completed, and the period T(3) during which the lighting of the light emitting thyristor L3 is controlled is started.

After that, those described up to now are repeated.

In addition, when the light emitting thyristors L are not lit (light emission), but kept unlit (non-lighting), the lighting signal φ1 may be kept at “H” (0 V), like the lighting signal φI1 shown at the time j to the time k in the period T(4) during which the lighting of the light emitting thyristor L4 of FIG. 8 is controlled. By doing in this way, even if the threshold voltage of the light emitting thyristors L4 is −1.5 V, the light emitting thyristor L4 is kept unlit (non-lighting).

As described above, the gate terminals Gt of the transmission thyristors T are mutually connected by the coupling diodes Dx. Hence, when the potential of a gate terminal Gt changes, the potentials of the gate terminals Gt connected to the gate terminal Gt whose potential has changed via the coupling diodes Dx of a forward bias change. Then, the threshold voltage of a transmission thyristor T having a gate terminal whose potential has changed changes. When the threshold voltage of the transmission thyristor T is higher (a negative value with a small absolute value) than “L” (−3.3 V), the first transmission signal φ1 or the second transmission signal φ2 is turned on at the timing when the voltage shifts to “L” (−3.3 V) from “H” (0 V).

Since a light emitting thyristor L whose gate terminal Gl is connected to the gate terminal Gt of the transmission thyristor T in an ON state have a threshold voltage of −1.5 V, the light emitting thyristor is turned on and lit (light emission) if the lighting signal φI shifts to “L” from “H”.

That is, as the transmission thyristor T is turned on, a light emitting thyristor L to be subjected to lighting control is specified, and the lighting signal φI sets the light emitting thyristor L to be subjected to lighting control to lighting or non-lighting.

In this way, the waveform of the lighting signal φI is set according to image data, thereby controlling lighting or non-lighting of the respective light emitting thyristors L.

In the first embodiment, as shown in FIG. 6, the lens 92 is provided so as to face the light emitting face 311 of the light emitting thyristor L, and a part of the light that is emitted from the light emitting face 311 and proceeds laterally (in an oblique direction) with respect to the light emitting face 311 is condensed by the lens 92 and is turned into the light that proceeds forward (perpendicular direction) with respect to the light emitting face 311. Thereby, the extraction efficiency of light is improved compared to a case where the lens 92 is not provided.

In a case where lenses are provided in correspondence with plural light emitting faces of a light emitting element array of a light emitting component, suppressing of damage (cracking) of a substrate provided with the light emitting element array caused by the stress produced by the formation of pedestals for installing the lenses is required. In the first embodiment, the pedestal 91 is made cylindrical. In this case, the area of the pedestal 91 that comes into contact with the substrate 80 is small compared with a case where the pedestal 91 is provided in the whole surface. Hence, the stress that the pedestal 91 exerts on the substrate 80 is also small compared to the case where the pedestal 91 is provided in the whole surface.

Moreover, when the light emitting face 311 and the lens 92 come into contact with each other, the quantity of light extracted from the lens 92 decreases due to multiple interference. However, in the present exemplary embodiment, the gap 93 is provided between the light emitting face 311 and the lens 92 to suppress a decrease in the quantity of light extracted from the lens 92 caused by multiple interference. In addition, the distance between the light emitting face 311 and the lens 92 (the length of the gap 93) may have a value at which a decrease in the quantity of light is suppressed by multiple interference.

In addition, it is preferable to set the focus of the lens 92 in the light emitting face 311 in respect of condensing.

### Second Embodiment

The second embodiment is different from the first embodiment in the shape of the pedestal 91 of the light emitting chip C. That is, although the pedestal 91 is cylindrical in the first embodiment, the pedestal is formed in the shape of parallel crosses in the second embodiment. Other configurations are the same as those of the first embodiment. Hence, the portions different from the first embodiment, i.e., the portions relevant to the pedestal 91 of the light emitting chip C in the second embodiment will be described, and the description of the same portions as the first embodiment will be omitted.

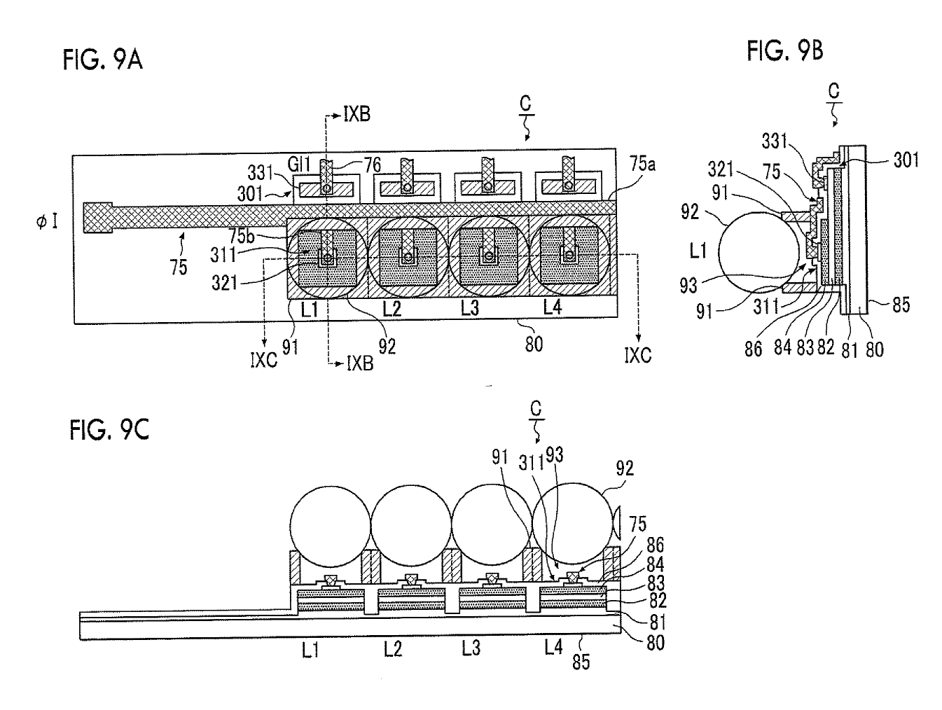

FIGS. 9A to 9C are a plan view and sectional views of some of the light emitting thyristors L of the light emitting chip C in the second embodiment. FIG. 9A is a plan view, FIG. 9B is a sectional view in the line IXB-IXB of FIG. 9A, and FIG. 9C is a sectional view in the line IXC-IXC of FIG. 9A. In addition, in FIG. 9A, the lens 92 is transparent, and only the external shape thereof is shown.

The pedestal 91 is in the shape of parallel crosses, and the opening of each parallel-cross-shaped pedestal 91 and the light emitting face 311 of each light emitting thyristor L face each other. The light emitted from the light emitting face 311 may be condensed and extracted by the lens 92 provided in the opening of the parallel-cross-shaped pedestal 91.

In FIGS. 9A and 9C, the pedestal 91 is shown by delimiting by a broken line for every light emitting thyristor L. The pedestal 91 is angled cylindrical as seen for every light emitting thyristor L. Also in the second embodiment, the height (the length in a direction perpendicular to the light emitting face 311) of the pedestal 91 is set so as to provide the gap 93 between the light emitting face 311 and the lens 92.

By forming making a pedestal 91 in the shape of parallel crosses, the area by which the pedestal 91 shields the light emitting face 311 is suppressed.

The light emitting chip C having the pedestal 91 of the second embodiment may be manufactured by a manufacturing method described in the first embodiment.

### Third Embodiment

The third embodiment is different from the first embodiment in the shape of the pedestal 91 of the light emitting chip C. That is, although the pedestal 91 is cylindrical in the first embodiment, pedestals are formed in the shape of a column at the four corners of the light emitting face 311 in the third embodiment. Other configurations are the same as those of the first embodiment. Hence, the portions different from the first embodiment, i.e., the portions relevant to the pedestal 91 of the light emitting chip C in the third embodiment will be described, and the description of the same portions as the first embodiment will be omitted.

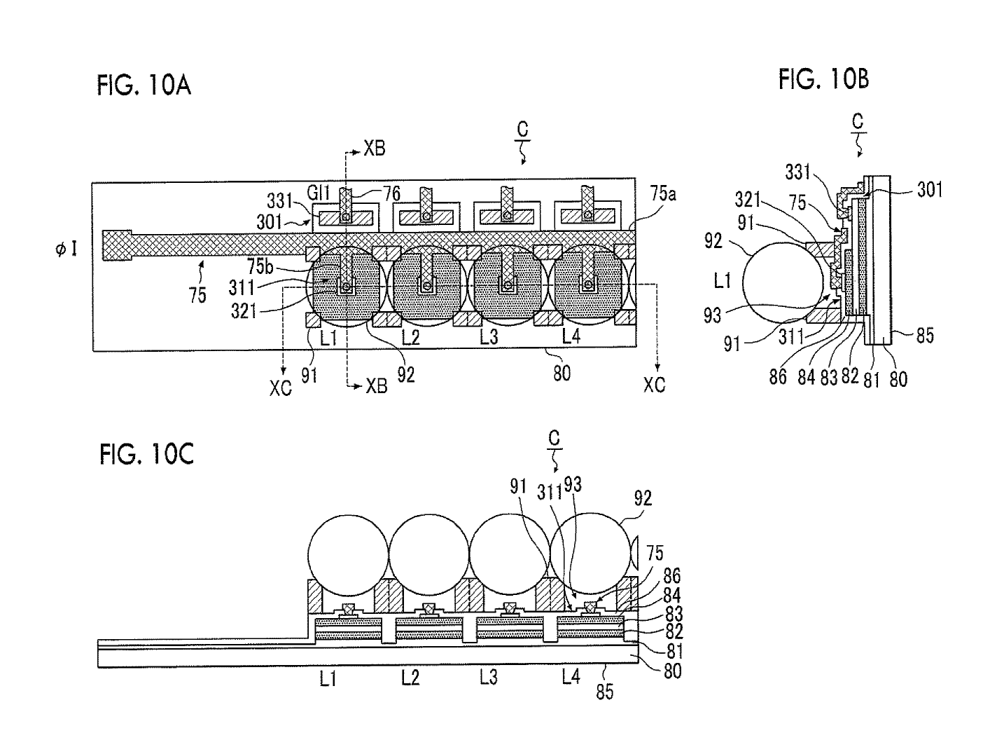

FIGS. 10A to 10C are a plan view and sectional views of some of the light emitting thyristors L of the light emitting chip C in the third embodiment. FIG. 10A is a plan view, FIG. 10B is a sectional view in the line XB-XB of FIG. 10A, and FIG. 100 is a sectional view in the line XC-XC of FIG. 10A. In addition, in FIG. 10A, the lens 92 is transparent, and only the external shape thereof is shown.

The pedestals 91 provided at the four corners (peripheral portion of the light emitting face 311) of the light emitting face 311 of each light emitting thyristor L are columnar. That is, in the present exemplary embodiment, four pedestals 91 are provided per one light emitting thyristor L, and one lens 92 is held by these four pedestals 91.

Although the portions between the pedestals 91 between adjacent light emitting thyristors L are shown by broken lines in FIGS. 10A and 10C, these have an integrated columnar shape.

Also in the third embodiment, the height (the length in a direction perpendicular to the light emitting face 311) of the pedestals 91 is set so as to provide the gap 93 between the light emitting face 311 and the lens 92.

By providing the columnar pedestals 91 at the four corners of the light emitting face 311, the area by which the pedestals 91 shield the light emitting face 311 is suppressed.

The light emitting chip C having the pedestals 91 of the third embodiment may be manufactured by the manufacturing method described in the first embodiment.

In addition, although one lens 92 is held by the four pedestals 91, one lens 92 is held by three pedestals 91. Although not shown, the area by which the pedestals 91 shields the light emitting face 311 may be further suppressed by forming one pedestal 91 on the branch portion 75b.

### Fourth Embodiment

The fourth embodiment is different from the first embodiment in the shape of the lens 92 of the light emitting chip C. That is, although the lens 92 is spherical (ball lens) in the first embodiment, the lens is formed in a semispherical shape (semispherical lens) that becomes convex in the direction away from the light emitting face 311 in the third embodiment. Other configurations are the same as those of the first embodiment. Hence, the portions different from the first embodiment, i.e., the portions relevant to the lens 92 of the light emitting chip C in the fourth embodiment will be described, and the description of the same portions as the first embodiment will be omitted.

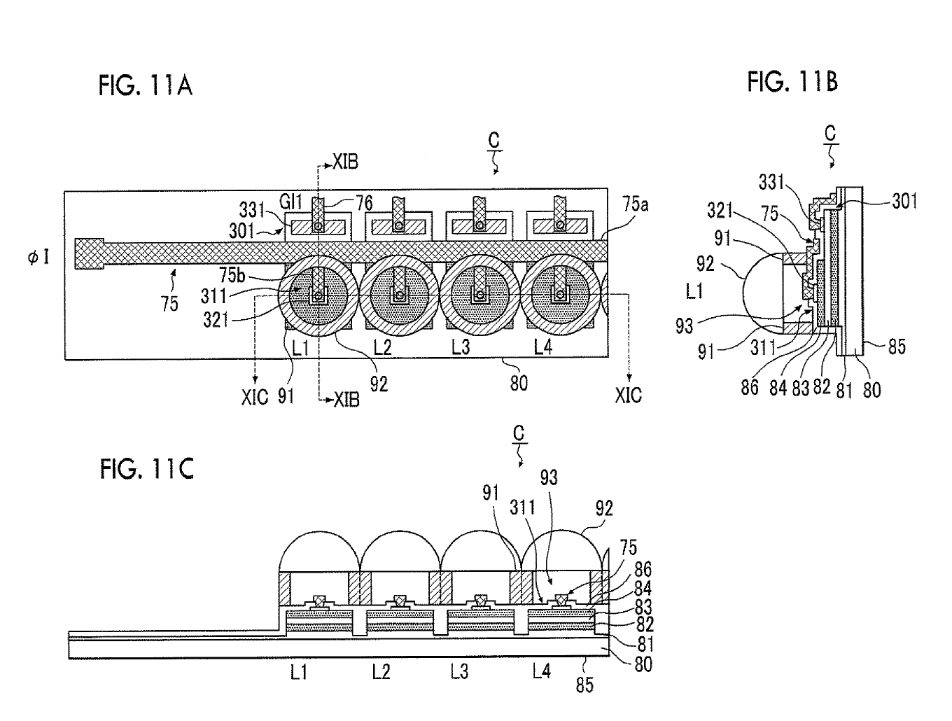

FIGS. 11A to 11C are a plan view and sectional views of some of the light emitting thyristors L of the light emitting chip C in the fourth embodiment. FIG. 11A is a plan view, FIG. 11B is a sectional view in the line XIB-XIB of FIG. 11A, and FIG. 11C is a sectional view in the line XIC-XIC of FIG. 11A. In addition, in FIG. 11A, the lens 92 is transparent, and only the external shape thereof is shown.

The pedestal 91 with respect to the light emitting face 311 of each light emitting thyristor L is cylindrical similarly to the first embodiment, and the semispherical lens 92 is arranged on the pedestal. In addition, the lens 92 has a semispherical shape that becomes convex in the direction away from the light emitting face 311.

The semispherical lens 92 condenses the light that is emitted from the light emitting face 311 and proceeds laterally (oblique direction) with respect to the light emitting face 311, and provides the light that proceeds forward (perpendicular direction) with respect to the light emitting face 311. Thereby, the extraction efficiency of the light emitted from the light emitting face 311 is improved.

The light emitting chip C having the lens 92 of the fourth embodiment may be manufactured by the manufacturing method described in the first embodiment.

In addition, although the lens 92 has a semispherical shape that becomes convex in the direction away from the light emitting face 311 in FIGS. 11B and 11C, the lens may have a semispherical shape that becomes convex in the direction approaching the light emitting face 311.

Additionally, the shape of the pedestal 91 may be the shapes shown in the second embodiment or the third embodiment.

### Fifth Embodiment

The fifth embodiment is different from the first embodiment in the shape of the pedestal 91 and lens 92 of the light emitting chip C. That is, in the first embodiment, the pedestal 91 is cylindrical and the lens 92 is spherical. However, in the fifth embodiment, pedestals 91 are provided along two facing sides of the light emitting face 311, and the lens 92 is made columnar (columnar lens). Other configurations are the same as those of the first embodiment. Hence, the portions different from the first embodiment, i.e., the portions relevant to the pedestals 91 and lens 92 of the light emitting chip C in the fifth embodiment will be described, and the description of the same portions as the first embodiment will be omitted.

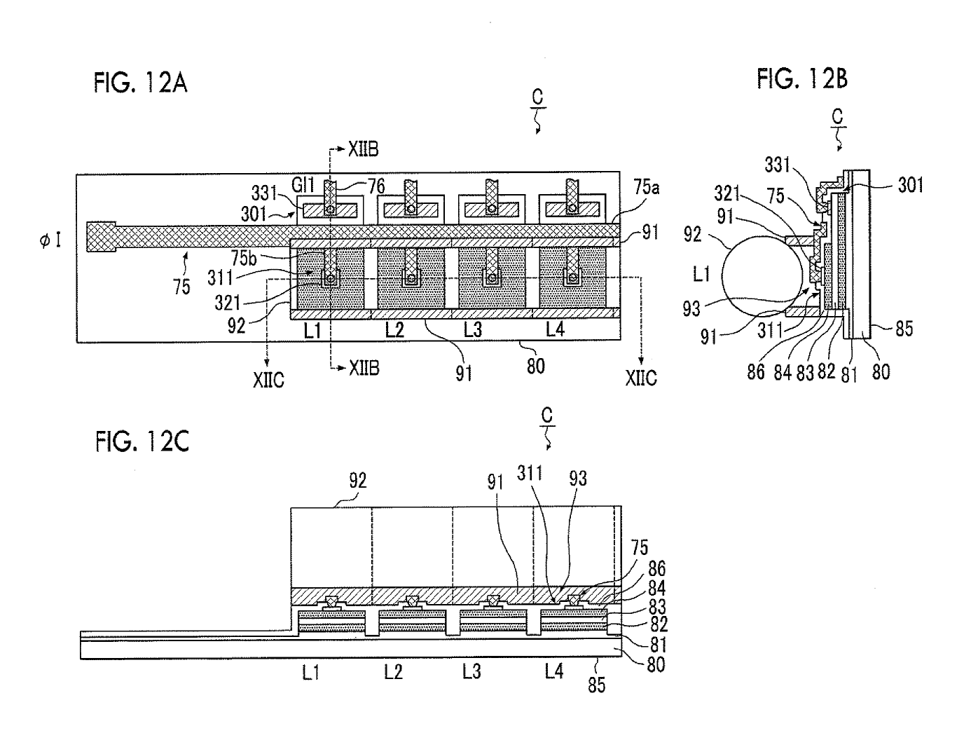

FIGS. 12A to 12C are a plan view and sectional views of some of the light emitting thyristors L of the light emitting chip C in the fifth embodiment. FIG. 12A is a plan view, FIG. 12B is a sectional view in the line XIIB-XIIB of FIG. 12A, and FIG. 12C is a sectional view in the line XIIC-XIIC of FIG. 12A.

The pedestals 91 are provided in the shape of walls along the direction of the row of the light emitting thyristors L at two opposite sides of the light emitting face 311. The lens 92 is columnar (columnar lens) that has the central axis of a cylinder in the direction of the row of the light emitting thyristors L. In addition, the columnar lens is referred to as a cylindrical lens.

In addition, although the portion between adjacent lenses 92 is shown by a broken line, the adjacent lenses 92 are integrated. That is, the lens 92 becomes fiber-like (glass fiber).

When the lens 92 is fiber-like, the lens 92 is not installed in every light emitting thyristor L, and the fiber-like lens 92 may be collectively installed to the plural light emitting thyristors L.

Additionally, when the lens 92 is fiber-like, the lens 92 condenses the light that is emitted from the light emitting face 311 and proceeds laterally (oblique direction) with respect to the light emitting face 311, and provides the light that proceeds forward (perpendicular direction) with respect to the light emitting face 311. Thereby, the extraction efficiency of the light emitted from the light emitting face 311 is improved.

The light emitting chip C having the pedestals 91 and lens 92 of the fifth embodiment may be manufactured by the manufacturing method described in the first embodiment.

Additionally, the shape of the pedestals 91 may be the shape shown in the third embodiment.

### Sixth Embodiment

The sixth embodiment is different from the first embodiment in the configuration of the pedestal 91 of the light emitting chip C. That is, the pedestal 91 is made of polyimide in the first embodiment. The polyimide assumes brown. In contrast, in the sixth embodiment, the face (lateral face inside the pedestal 91) of the pedestal 91 that views the light emitting face 311 is used as the face that is easy to absorb the light (for example, the light with a light emission wavelength of 780 nm) emitted from the light emitting thyristor L. That is, the pedestal 91 is made of black polyimide. Other configurations are the same as those of the first embodiment. Hence, the portions different from the first embodiment, i.e., the portions relevant to the pedestal 91 of the light emitting chip C in the sixth embodiment will be described, and the description of the same portions as the first embodiment will be omitted.

As mentioned above, in addition to the light that proceeds forward with respect to the light emitting face 311, light is emitted also laterally from the light emitting face 311. The light that enters the lens 92 of these is condensed by the lens 92, is extracted, and used for image formation. However, the light that does not enter the lens 92 becomes stray light, which is not desirable in image formation.

In the sixth embodiment, the pedestal 91 is made of black polyimide so as to form the face that is easy to absorb the light emitted from the light emitting thyristor L. Thereby, the stray light is absorbed.

As a method of making the pedestal 91 of black polyimide, powder (carbon black) of carbon is mixed in, for example, a photosensitive polyimide film 94 shown in FIG. 7B so as to form the pedestal 91.

Additionally, the pedestal 91 may be formed using other black materials.

In addition, in the sixth embodiment, the shape of the pedestal 91 is preferably configured so as to surround the light emitting face 311 as in the first embodiment or the second embodiment.

### Seventh Embodiment

The seventh embodiment is different from the first embodiment in the configuration of the pedestal 91 of the light emitting chip C. That is, in the seventh embodiment, the face (lateral face inside the pedestal 91) of the pedestal 91 that views the light emitting face 311 is used as the face that is easy to reflect the light (for example, the light with a light emission wavelength of 780 nm) emitted from the light emitting thyristor L. Other configurations are the same as those of the first embodiment. Hence, the portions different from the first embodiment, i.e., the portions relevant to the pedestal 91 of the light emitting chip C in the seventh embodiment will be described, and the description of the same portions as the first embodiment will be omitted.

As mentioned above, in addition to the light that proceeds forward from the light emitting face 311, light is emitted also laterally from the light emitting face 311. The light that does not enter the lens 92 becomes stray light.

Thus, in the present exemplary embodiment, in order to reflect the light of the laterally emitted light that has entered the face inside the pedestal 91 so as to enter the lens 92, the face inside the pedestal 91 is used as a reflective layer with a high reflection factor with respect to the light emission wavelength of the light emitting thyristor L.

A method of forming the inner lateral face of the pedestal 91 as a reflective layer with a high reflection factor with respect to the light emission wavelength of the light emitting thyristor L will be described. A case where, for example, aluminum (Al) is used as the reflective layer will be described.

As shown in FIG. 7C, the pedestals 91 of the light emitting chip C are formed.

Then, an Al thin film is deposited on the surface on the side where the pedestals 91 of the light emitting chip C are formed, by the sputtering method or the like. Then, the Al thin film is etched by the ion etching method or the like. At this time, ions for etching are made to enter the surface (light emitting face 311) of the substrate 80 perpendicularly. Then, although the Al thin film on the light emitting face 311 that is a face parallel to the surface of the substrate 80 is etched and removed, the Al thin film on the lateral face of a pedestal 91 that are a perpendicular face to the surface of the substrate 80 is hardly etched. Hence, an Al reflective layer may be formed on the lateral face of the pedestal 91.

In addition, the material of the reflective layer is not limited to Al, and may be those having a high reflection factor with respect to the light emitted from the light emitting thyristor L, such as silver (Ag), chromium (Cr), and gold (Au).

Although the shape of the light emitting face 311 has been described as a horseshoe shape in the first to seventh embodiments, the shape of the light emitting face may be other shapes by changing the position where the n-type ohmic electrode 321 is provided. Additionally, although the external shape of the light emitting face 311 is square in FIG. 6A or the like, the external shape of the light emitting face may be other shapes, such as a rectangular shape.

Moreover, although the pitch of the row of the light emitting thyristors L has been 20 μm, the pitch may have other values.

In the first embodiment, the value of “H” (0 V) that is a high-level potential, and “L” (−3.3 V) that is a low-level potential are examples, respectively, and may be set to other values in consideration of the operation of the light emitting device 65.

In the first embodiment, although the transmission thyristors T are driven in two phases of the first transmission signal φ1 and the second transmission signal φ2, three-phase transmission signals may be transmitted so as to drive every three transmission thyristors T.

In addition, in the first embodiment, although one self-scanning type light emitting element array (SLED) is mounted on the light emitting chip C, two or more self-scanning type light emitting element arrays may be mounted. when two or more self-scanning type light emitting element arrays are mounted, the self-scanning type light emitting element arrays (SLED) may be replaced with the light emitting chips C, respectively.

In the first embodiment, an anode common in which the anode terminals of the thyristors (the transmission thyristors T and the light emitting thyristors L) are made in common for the substrate 80 has been described. Even a cathode common in which the cathode terminals are made in common for the substrate 80 may be used by changing the polarity of a circuit.

Moreover, although the light emitting thyristors L have been described as the light emitting elements, the light emitting elements may be other devices, such as light emitting diodes.

### EXAMPLES

Next, an example will be described.

The light emitting chips C of an example and a comparative example shown below are manufactured using a GaAs substrate 80 with a diameter 6 inches and a thickness of 300 μm.

The light emitting chip C shown in the example has the structure shown in FIG. 6.

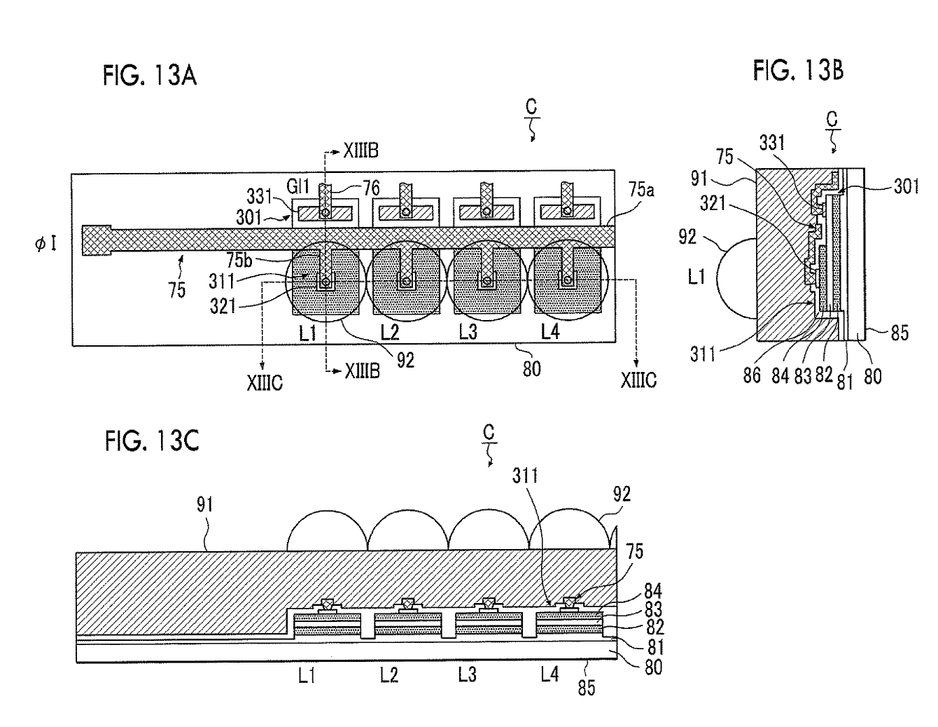

FIGS. 13A to 13C are a plan view and sectional views of some of light emitting thyristors L of a light emitting chip C in a comparative example. FIG. 13A is a plan view, FIG. 13B is a sectional view in the line XIIIB-XIIIB of FIG. 13A, and FIG. 13C is a sectional view in the line XIIIC-XIIIC of FIG. 13A. In addition, description of the pedestal 91 is omitted in FIG. 13A.

In FIG. 7B, the pedestal 91 of the comparative example is made into a pedestal 91 by imidizing the photosensitive polyimide film 94 by heating without radiating the light 97 except for bonding pads. That is, as shown in FIGS. 13B and 13C, the pedestal 91 is provided on the whole surface except for bonding pads in which the light emitting thyristors L of the substrate 80 are provided. The same semispherical lens 92 as the fourth embodiment is provided so as to face the light emitting face 311 of each light emitting thyristor L.

In the example and the comparative example, the increase amount (μm) of the deflection amount of the substrate 80 is compared in the state before being split into respective light emitting chips C. The deflection amount is measured by a flatness tester using laser interference.

Table 1 shows the increase amount (μm) of the deflection amount in the example and the comparative example.

TABLE 1

| | Increase Amount of |
|---|---|
| | Deflection Amount (μm) |
| Example | 17 |
| Comparative Example | 354 |

As shown in Table 1, the increase amount of the deflection amount in the example in which the pedestal 91 is not provided on the whole surface of the substrate 80 becomes 1/20 or less of that in the comparative example in which the pedestal 91 is provided on the whole surface.

This is because the photosensitive polyimide film 94 contracts at the time of heating, and the side where the photosensitive polyimide film 94 has been formed is deflected concavely, since the pedestal 91 is formed the whole surface of the substrate 80 in the comparative example. Then, a stress is applied to the substrate 80, and damage (cracking) of the substrate 80 becomes apt to occur.

On the other hand, in the example, the area of the pedestal 91 that comes into contact with the substrate 80 side is reduced generating of the stress caused by the formation of the pedestal 91 is suppressed, by forming the pedestal 91 at the end of the light emitting face 311.

That is, generation of the stress caused by the formation of the pedestal 91 is suppressed by reducing the area of the pedestal 91 that comes into contact with the substrate 80 side.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light emitting component comprising:
a plurality of light emitting elements arranged in rows on a substrate;
a plurality of lenses provided to face light emitting faces to which light beams of the plurality of light emitting elements are emitted, and condensing the light beams emitted from the light emitting elements; and
one or a plurality of pedestals holding the lenses such that the light emitting faces of the respective light emitting elements of the plurality of light emitting elements and the lenses that face the light emitting elements face the light emitting faces via gaps.

2. The light emitting component according to claim 1,
wherein the lens of the plurality of lenses is a cylindrical lens whose axis is set in a direction along the row of the plurality of light emitting elements, and is one cylindrical lens in which that the plurality of lenses is integrated.

3. The light emitting component according to claim 1,
wherein the light emitting element of the plurality of light emitting elements is a light emitting thyristor of a self-scanning type light emitting element array.

4. The light emitting component according to claim 1,
wherein the face of the pedestal capable of viewing the light emitting face of the light emitting element is a face that easily absorbs the light beam emitted from the light emitting element.

5. The light emitting component according to claim 1
wherein the face of the pedestal capable of viewing the light emitting face of the light emitting element is a face that easily reflects the light beam emitted from the light emitting element.

6. A print head comprising:
a light emitting unit including a plurality of light emitting elements arranged in rows on a substrate, a plurality of lenses provided to face light emitting faces to which light beams of the plurality of light emitting elements are emitted, and condensing the light beams emitted from the light emitting elements; and one or a plurality of pedestals holding the lenses such that the light emitting faces of the respective light emitting elements of the plurality of light emitting elements and the lenses that face the light emitting elements face the light emitting faces via gaps, and
an optical unit that focuses the light radiated from the light emitting unit.

7. The print head according to claim 6,
wherein the lens of the plurality of lenses is a cylindrical lens whose axis is set in a direction along the row of the plurality of light emitting elements, and is one cylindrical lens in which that the plurality of lenses is integrated.

8. The print head according to claim 6,
wherein the light emitting element of the plurality of light emitting elements is a light emitting thyristor of a self-scanning type light emitting element array.

9. The print head according to claim 6,
wherein the face of the pedestal capable of viewing the light emitting face of the light emitting element is a face that easily absorbs the light beam emitted from the light emitting element.

10. The print head according to claim 6,
wherein the face of the pedestal capable of viewing the light emitting face of the light emitting element is a face that easily reflects the light beam emitted from the light emitting element.

11. An image forming apparatus comprising:
an image carrier;
a charging unit charging the image carrier;
an exposure unit including a plurality of light emitting elements arranged in rows on a substrate, a plurality of lenses provided to face light emitting faces to which light beams of the plurality of light emitting elements are emitted, and condensing the light beams emitted from the light emitting elements, and one or a plurality of pedestals holding the lenses such that the light emitting faces of the respective light emitting elements of the plurality of light emitting elements and the lenses that face the light emitting elements face the light emitting faces via gaps, and exposing the image carrier via the optical unit to form an electrostatic latent image;
a developing unit developing the electrostatic latent image formed on the image carrier, and
a transfer unit transferring an image developed on the image carrier to a medium.

12. The image forming apparatus according to claim 11,
wherein the lens of the plurality of lenses is a cylindrical lens whose axis is set in a direction along the row of the plurality of light emitting elements, and is one cylindrical lens in which that the plurality of lenses is integrated.

13. The image forming apparatus according to claim 11,
wherein the light emitting element of the plurality of light emitting elements is a light emitting thyristor of a self-scanning type light emitting element array.

14. The image forming apparatus according to claim 11,
wherein the face of the pedestal capable of viewing the light emitting face of the light emitting element is a face that easily absorbs the light beam emitted from the light emitting element.

15. The image forming apparatus according to claim 11,
wherein the face of the pedestal capable of viewing the light emitting face of the light emitting element is a face that easily reflects the light beam emitted from the light emitting element.
